(19) United States
(12) Patent Application Publication
(10) Pub. No.: US 2005/0099533 A1
(43) Pub. Date: May 12, 2005

(54) Image capturing apparatus and camera module

(75) Inventors: Takao Matsuda, Tokyo (JP); Shoichi Nagatomo, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: CASIO COMPUTER CO., LTD., Tokyo (JP)

(21) Appl. No.: 10/982,341

(22) Filed: Nov. 4, 2004

(30) Foreign Application Priority Data
Nov. 10, 2003 (JP) 2003-379687
Nov. 10, 2003 (JP) 2003-379691
Sep. 30, 2004 (JP) 2004-288337
Oct. 1, 2004 (JP) 2004-289617

(51) Int. Cl. H04N 5/225

(52) U.S. Cl. 348/375

(57) ABSTRACT

In a folding type portable electronic appliance, the portable electronic appliance is equipped with a main body portion having a wireless unit, a lid portion having a display unit, and a coupling portion for hinge-coupling the main body portion in a pivotable manner on one edge side thereof and for hinge-coupling the lid portion in a pivotable manner on the other edge side thereof. In the portable electronic appliance, the lid portion is foldable with respect to the main body portion, and a camera module is further provided on the coupling portion, which is directed from the main body portion to the lid portion. In addition, the portable electronic appliance is equipped with a camera control unit for controlling an imaging operation of the camera module, a control unit for controlling initiating/accomplishing operations of the camera module and for controlling the wireless unit, and an address/data bus processing unit for controlling data communication operations of the respective units.

### BACKGROUND OF THE INVENTION

1. Field of the Invention

The present invention generally relates to an image capturing apparatus equipped with a foldable main body and lid portion, and relates to a camera module. More specifically, the present invention is directed to the image capturing apparatus and the camera module, capable of quickly switching photograph modes such as a scene photographing mode, a self-portrait photographing mode, and an others-portrait photographing mode.

2. Description of the Related Art

Various folding type of portable telephones have been marketed which are constructed in such a manner that main body portions having key input operating portions are hinged on one end sides of coupling portions whereas lid portions having display portions are hinged on the other end sides of the coupling portions. Among these folding type portable telephones, such portable telephones equipped with cameras are marketed, in which camera units are mounted on coupling portions.

Further, there are other portable telephones equipped with cameras, in which camera units are rotatably assembled in hinge portions for hinge-coupling main body portions with lid portions.

However, in the above-described constructions of these conventional portable telephones equipped with cameras, when these conventional portable telephones are used as cameras while viewing the display portions of the lid portions as view finders (monitors), various cumbersome operations by users are necessarily required. That is, for instance, in the case that photographing modes of a camera unit of such a conventional portable telephone equipped with a camera are switched from both a scene photographing mode and an others-portrait photographing mode to a self-portrait photographing mode, and vice versa, the camera unit must be manually rotated so as to change a photograph direction of this camera unit to a reverse photograph direction, and/or this portable telephone equipped with the camera must be turned over by a hand of a user.

### SUMMARY OF THE INVENTION

The present invention has been made to solve the above-explained problems, and therefore, has an object to provide an image capturing apparatus such as a folding type portable electronic appliance equipped with a camera, capable of quickly switching a scene photographing mode, an others-portrait photographing mode, and a self-portrait photographing mode in a simple manner.

Another object of the present invention is to provide such an folding type portable electronic appliance equipped with a camera, which is capable of switching process operations such as a communication process operation and an imaging process operation in a smooth manner.

A further object of the present invention is to provide a camera module such as a portable telephone equipped with a camera, which requires high density mounting techniques, and is equipped with a compact-designed lens drive mechanism.

To achieve the above-described objects, an image capturing apparatus, recited in claim 1, is featured by comprising: a main body portion; a lid portion; and a coupling portion which contains a first pivotable shaft coupled to the main body portion, a second pivotable shaft coupled to the lid portion, a lens in which a direction for intersecting both the first pivotable shaft and the second pivotable shaft respectively at a substantially right angle is set as an optical axis of the lens, and image capturing unit for imaging a photographic object entered thereinto via the lens.

Also, an image capturing apparatus, recited in claim 2, is featured by that in the image capturing apparatus recited in claim 1, the main body portion is comprised of operation unit; the lid portion is comprised of first display unit; and the image capturing apparatus is further comprised of: capture control unit for controlling the image capturing unit based upon the operation by the operation unit; and first display control unit for displaying an image acquired by the image capturing unit under control of the capture control unit on the first display unit.

Furthermore, an image capturing apparatus, recited in claim 4, is featured by that the image capturing apparatus, recited in claim 2, is further comprised of: wireless communication unit for performing a wireless communication process operation with respect to an external unit; second display control unit for displaying information related to the wireless communication process operation by the wireless communication unit on the first display unit; and process control unit operated in such a manner that when an imaging operation is carried out by the image capturing unit under control of the image control unit, the display control operation by the first display control unit is carried out in a top priority, as compared with the display control operation by the second display control unit.

Also, to achieve the above-described objects of the present invention, a camera module, recited in claim 11, is featured by such a camera module build in a housing equipped with a first pivotable shaft and a second pivotable shaft, comprising: a lens in which a direction for intersecting both the first pivotable shaft and the second pivotable shaft respectively at a substantially right angle is set as an optical axis of the lens; image capturing unit for imaging a photographic object entered via the lens; and drive unit for driving the lens.

### BRIEF DESCRIPTION OF THE DRAWINGS

A better understanding of the present invention may be made by reading a detailed description with reference to the accompanying drawings, in which:

FIG. 1 is a perspective view for showing a condition under which a lid portion 2 is overlapped on a main body portion 1 in a portable telephone 100 according to an embodiment mode 1 to which the present invention has been applied;

FIG. 2A is a perspective view for representing such a condition that the lid portion 2 is opened to be positioned on an extension line of the main body portion 1 in the portable telephone 100 of FIG. 1;

FIG. 2B is a perspective view for representing such a condition transferred from the condition shown in FIG. 2A, under which both a camera unit 31 and a flash-purpose LED 32 of a coupling portion 3 are rotated so as to be moved from a front plane side to a rear plane side in the portable telephone 100;

FIG. 3 is a perspective view for indicating a shape of the coupling portion 3 shown in FIG. 2B;

FIG. 4A is a side view of the portable telephone 100, which indicates such a condition that the lid portion 2 is overlapped on the main body portion 1;

FIG. 4B is a side view of the portable telephone 100, which represents such a condition that the lid portion 2 is opened to be positioned on the extension line of the main body portion 1;

FIG. 4C is a side view of the portable telephone 100, for indicating such a condition transferred from that of FIG. 4C, under which both the camera unit 31 and the flash-purpose LED 32 of the coupling portion 3 are rotated so as to be moved from the front plane side to the rear plane side;

FIG. 5 is a block diagram for schematically showing a communication processing unit, an image processing unit, and a control processing unit of the portable telephone 100;

FIG. 6 is a perspective view for showing a condition under which a lid portion 2 is overlapped on a main body portion 1 in a portable telephone 200 according an embodiment mode 2 to which the present invention has been applied;

FIG. 7A is a perspective view for representing such a condition that the lid portion 2 is opened to be positioned on an extension line of the main body portion 1 in the portable telephone 200 of FIG. 6;

FIG. 7B is a perspective view for representing such a condition transferred from the condition shown in FIG. 7A, under which both a camera unit 31 and a flash-purpose LED 32 of a coupling portion 3 are faced to a front plane side;

FIG. 7C is a perspective view for representing such a condition transferred from the condition shown in FIG. 7A, under which both a camera unit 31 and a flash-purpose LED 32 of a coupling portion 3 are faced to a rear plane side;

FIG. 8 is a perspective view for indicating a shape of the coupling portion 3 shown in FIG. 7B;

FIG. 9A is a side view of the portable telephone 200, which indicates such a condition that the lid portion 2 is overlapped on the main body portion 1;

FIG. 9B is a side view of the portable telephone 200, which represents such a condition that the lid portion 2 is opened to be positioned on the extension line of the main body portion 1;

FIG. 9C is a side view of the portable telephone 200, for indicating such a condition transferred from that of FIG. 9B, under which both the camera unit 31 and the flash-purpose LED 32 of the coupling portion 3 are faced to the front plane side;

FIG. 9D is a side view of the portable telephone 200, for indicating such a condition transferred from that of FIG. 9B, under which both the camera unit 31 and the flash-purpose LED 32 of the coupling portion 3 are faced to the rear plane side;

FIG. 10 is a diagram for illustratively showing an electric connection construction inside a portable telephone 400 according to an embodiment mode 3 to which the present invention has been applied;

FIG. 11 is a block diagram for schematically showing functional structures employed in the portable telephone 400;

FIG. 12 represents signal flows in the portable telephone 400, namely, is a diagram for showing flows of control signals until a camera module is initiated;

FIG. 13 represents signal flows in the portable telephone 400, namely, is a diagram for showing flows of control signals and image signals when a through image is displayed;

FIG. 14 represents signal flows in the portable telephone 400, namely, is a diagram for showing flows of control signals and image signals until a photographed image is stored by depressing a shutter button;

FIG. 15 is a flow chart for explaining a sequential operation after the operation of the portable telephone 400 is advanced to a photograph mode until the photograph mode is accomplished;

FIG. 16A shows a display screen of the portable telephone 400, namely a diagram for indicating a waiting condition for a process operation thereof, or a telephone call waiting condition;

FIG. 16B shows a display screen of the portable telephone 400, namely a diagram for indicating that a photograph mode is being switched;

FIG. 16C shows a display screen of the portable telephone 400, namely a diagram for indicating that a though image is displayed;

FIG. 17A is a perspective view for showing a condition under which a lid portion 2 is overlapped on a main body portion 1 in a portable telephone 500 to which the present invention has been applied;

FIG. 17B is a perspective view for representing such a condition that the lid portion 2 is opened to be positioned on an extension line of the main body portion 1 in the portable telephone 500 of FIG. 17A;

FIG. 17C is a diagram for illustratively showing a photographing condition of the portable telephone 500;

FIG. 18A is a side view of the portable telephone 500, which indicates such a condition that the lid portion 2 is overlapped on the main body portion 1;

FIG. 18B is a side view of the portable telephone 500, which represents such a condition that the lid portion 2 is opened to be positioned on the extension line of the main body portion 1;

FIG. 19 is a block diagram for schematically showing a communication processing unit, an image processing unit, and a control processing unit of the portable telephone 500;

FIG. 20 is a side view for indicating an electric connection construction provided in a coupling portion under such a condition that both a main body portion 1 and a lid portion 2 of a portable telephone 500 are opened to be positioned on an extension line of the main body portion 1;

FIG. 21 is a front view for indicating construction provided in the coupling portion under such a condition that both the main body portion 1 and the lid portion 2 of the portable telephone 500 are opened to be positioned on the extension line of the main body portion 1;

FIG. 22 is a block diagram for schematically showing functional structures employed in the portable telephone 600;

FIG. 23 represents signal flows in the portable telephone 600, namely, is a diagram for showing flows of control signals until a camera module is initiated;

FIG. 24 represents signal flows in the portable telephone 600, namely, is a diagram for showing flows of control signals and image signals when a photographed image is displayed on a display unit;

FIG. 25 represents signal flows in the portable telephone 600, namely, is a diagram for showing flows of control signals and image signals until the photographed image is stored by depressing a shutter button; and

FIG. 26 is a flow chart for explaining a sequential operation after the operation of the portable telephone 500 is advanced to a photographing mode until the photographing mode is accomplished.

### DETAILED DESCRIPTION OF THE PREFERRED EMBODIMENTS

Referring now to drawings, various best modes for carrying out the invention as to image capturing apparatus and camera modules will be described in detailed.

Construction of First Portable Telephone 100

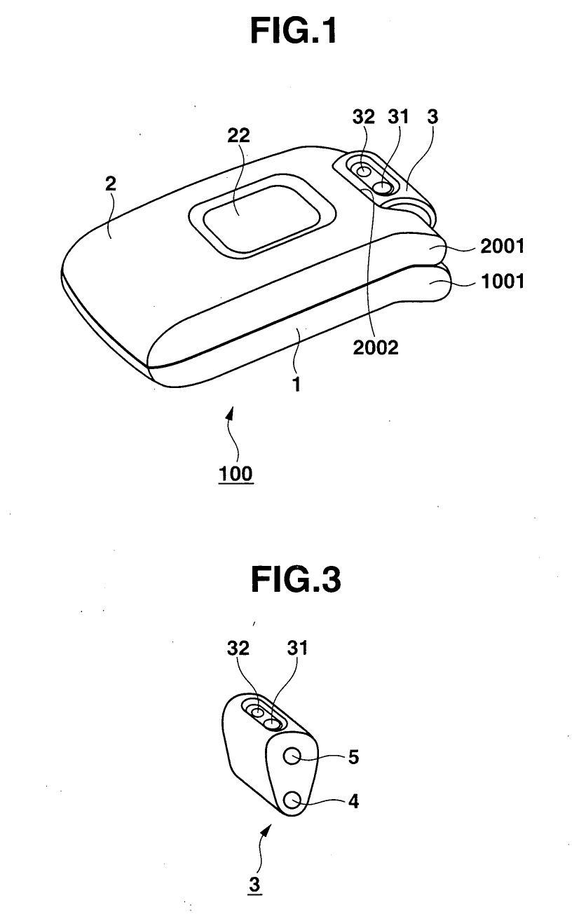

FIG. 1 to FIG. 4C shows a portable telephone 100 as an embodiment mode 1 as to both an image capturing apparatus and a camera module, to which the present invention has been applied. In these drawings, reference numeral 1 shows a main body, reference numeral 2 represents a lid portion, reference numeral 3 indicates a coupling portion, reference numeral 4 shows a first hinge portion, and reference numeral 5 denotes a second hinge portion.

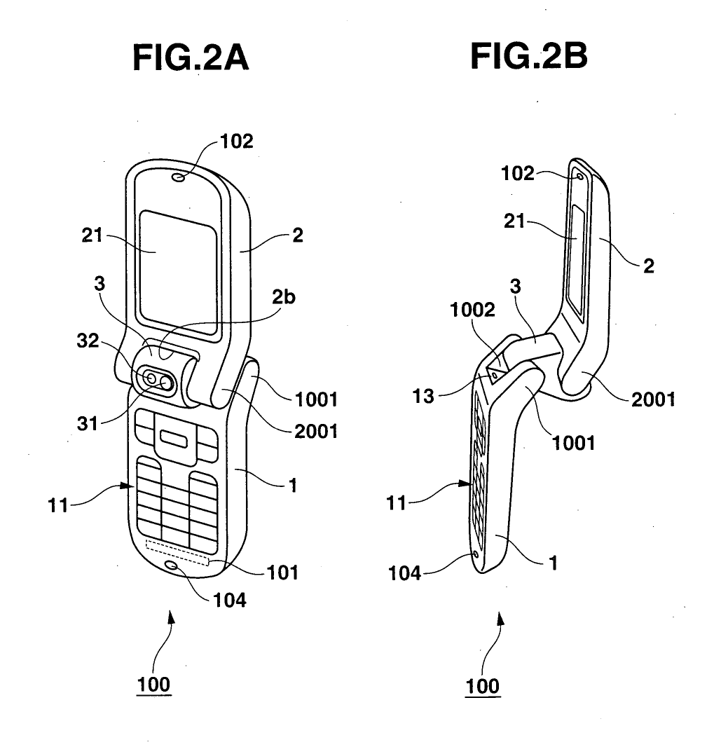

As shown in FIG. 2A, the main body portion 1 is equipped with an operation unit (input unit) 11, a built-in type antenna 101 (rectangular portion indicated by broken line), and a microphone 104 on one plane (left side plane as viewed in drawing) side. The operation unit 11 is constituted by various sorts of input keys and a ten-numeral enter key, and these input keys contain a camera key, a shutter key, and the like.

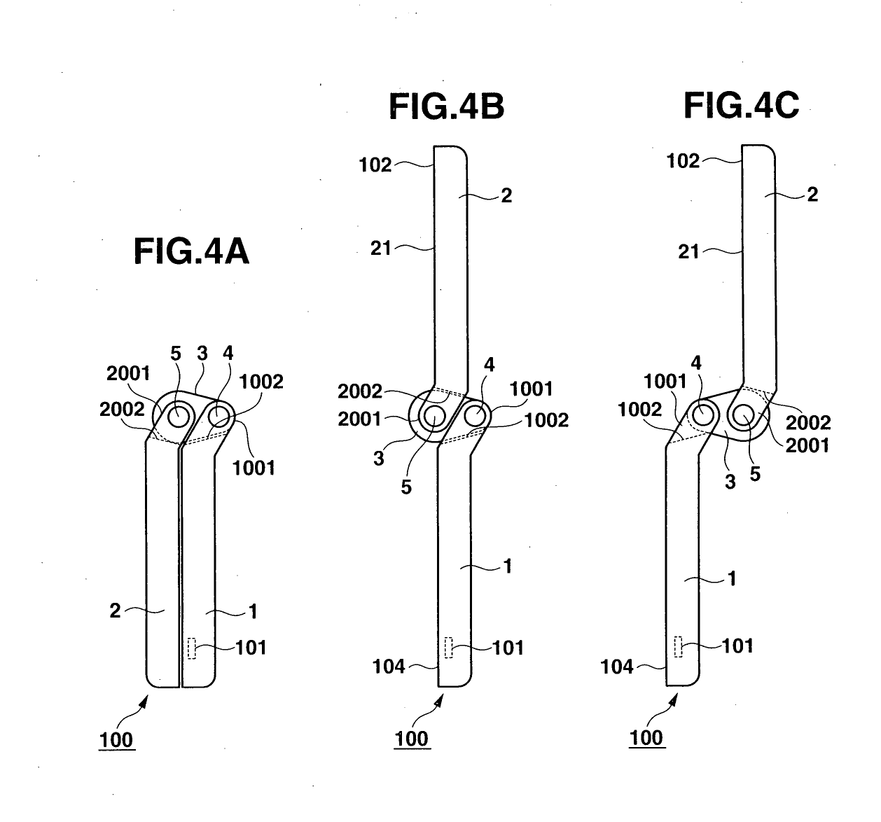

Also, as indicated in FIG. 1 and FIG. 4A, the lid portion 2 is overlapped on the main body portion 1 along a longitudinal direction on a plane having the operation unit 11 of this main body portion 1.

These main body portion 1 and lid portion 2 are assembled in a pivotable manner via the coupling portion 3 at a bent edge portion 1001 and another bent edge portion 2001, which are formed on one end sides of such a condition that the lid portion 2 is overlapped on the lid portion 2 along the longitudinal direction.

The lid portion 2 owns such a dimension capable of covering the main body portion 1, and is equipped with a main display unit 21 on the side of such a plane which is overlapped on the main body portion 1, and also, is equipped with a sub-display unit 22 on the side of a rear plane. The lid portion 2 is further equipped with a speaker 102.

As shown in FIG. 3, the coupling portion 3 is provided with the first hinge portion 4, the second hinge portion 5, and a camera unit 31, and also a flash-purpose LED (light emitting member) 32. Both the camera unit 31 and the flash-purpose LED 32 are arranged side by side on the edge plane which is directed from the first hinge portion 4 to the second hinge portion 5.

As shown in FIG. 2A, FIG. 2B, FIG. 4B, and FIG. 4C, this coupling portion 3 is coupled by the first hinge portion 4 in a pivotable manner with respect to the bent edge portion 1001 of the main body portion 1, and further, is coupled by the second hinge portion 5 in a pivotable manner with respect to the bent edge portion 2001 of the lid portion 2.

A notch portion 1002 and another notch portion 2002, which are employed so as to assemble thereinto the coupling portion 3, are formed in both the bent edge portion 1001 of the main body portion 1 and the bent edge portion 2001 of the coupling portion 3.

Also, as shown in FIG. 2B, a microswitch 13 for detecting a positional condition of the coupling portion 3 is provided on the notch portion 1002 of the main body portion 1.

Electronic Processing Units of First Portable Telephone 100

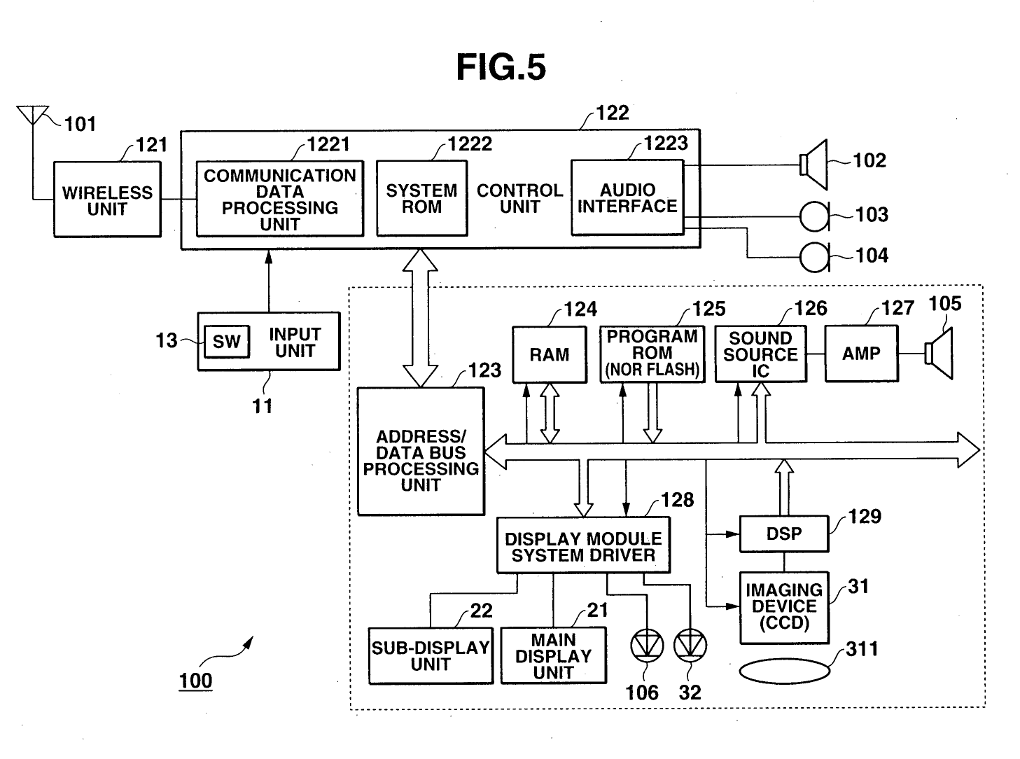

FIG. 5 is a schematic block diagram for showing communication/image/control processing units employed in the above-described portable telephone 100.

In this drawing, a wireless unit 121 corresponds to a circuit unit which is electrically connected to the built-in antenna 101, and drives/controls the built-in antenna 101. The wireless unit 121 performs a communication processing operation containing a modulation processing operation and a terminal authentication processing operation with respect to a wireless signal produced based upon a wireless communication system employed by an external communication service providing company. As the wireless communication system, for example, CDMA, PDC, and GSM communication systems are employed by communication service providing companies.

A control unit 122 controls an entire unit of the circuit of this portable telephone 100, and also, controls WWW (world wide web) connections established via communication service providing companies. The control unit 122 contains a communication data processing unit 1221, a system ROM (read-only memory) 1222, and an audio interface 1223. The communication data processing unit 1221 contains a voice decoding/coding process circuit, a packet data producing circuit, and a packet data restoring circuit, which are not shown in FIG. 5. This communication data processing unit 1221 executes a data processing operation in accordance with a communication protocol employed by a communication service providing company. A basic system for controlling a main portion of this portable telephone 100 has been stored in the system ROM 1222. The audio interface 1223 inputs/outputs a voice signal which is processed in the communication data processing unit 1221. A speaker 101, a recording microphone 103, and a microphone 104, which are provided in this portable telephone 100, are connected to the audio interface 1223.

An address data bus processing unit 123 controls and manages input/output timing of data with respect to the control unit 122 and peripheral circuits (namely, circuits surrounded by broken line of FIG. 5). A RAM (random access memory) 124 stores thereinto various sorts of data, for instance, address directory data which contain telephone numbers, mail data and Internet address which are used in network connections, image data acquired by an image capturing device (camera unit) 31, and the like. A program ROM 125 has previously stored thereinto various sorts of application programs which contain an image processing program. A sound source IC 126 stores thereinto waveforms of notification sounds, and also outputs melodies and the like as the notification sounds. An amplifier 127 amplifies an output signal derived from the sound source IC 126. A notification-purpose speaker 105 reproduces notification sounds.

A display module system driver 128 drives the main display unit 21, the sub-display unit 22, the flash-purpose LED 32, and a notification-purpose LED (light emitting diode) 106 provided on the portable telephone 100. The image capturing device (camera unit) 31 is constituted by a CCD (charge-coupled device) and the like, onto which an image of a photographic object is focused by a lens 311 of this image capturing device 31. A DSP (digital signal processor) 129 is to process an image signal derived from this image capturing device (camera unit) 31.

While the microswitch (SW) 13 is provided on the input unit (operations unit) 11 so as to detect operation conditions of the coupling portion 3, when this microswitch 13 is turned ON and OFF, the tops and bottoms of photograph data and of monitor display are controlled in a switching manner.

Operations of First Portable Telephone 100

As previously explained, in the portable telephone 100 of the first embodiment mode, the coupling portion 3 is coupled to the main body portion 1 in the pivotable manner by the first hinge portion 4, and also, is coupled to the lid portion 2 in the pivotable manner by the second hinge portion 5.

Under such a condition that the lid portion 2 is overlapped on the main body portion 1, as shown in FIG. 1 and FIG. 4A, in the portable telephone 100, the camera portion 31 mounted on the coupling portion 3 is directed from the side of the main body portion 1 to the side of the lid portion 3.

Then, the lid portion 2 is moved by the second hinge portion 5 of the coupling portion 3 in the pivotable manner so as to be opened with respect to the main body portion 1 from such a condition that this lid portion 2 is overlapped on the main body portion 1. Thus, when such a condition is obtained under which, as represented in FIG. 2A and FIG. 4B, the bent edge portion 1001 of the main body portion 1 and the bent edge portion 2001 of the lid portion 2 are located back to back, so that the lid portion 2 is located on an extension line of the main body portion 1, the main display unit 21, the camera unit 31, and the flash-purpose LED 32 are faced to the user (on the side of front plane) who holds the portable telephone 100 on his hand, which may suitably constitute such a condition that while the user monitors the main display unit 31 as the view finder (monitor), the user takes a self-portrait (namely, self-portrait photographing mode). Also, this condition is suitable for a use of the portable telephone 100 as a portable video phone.

From this condition, while the display direction of the main display unit 21 is maintained, the user moves the coupling portion 3 by the first hinge portion 4 in the pivotable manner in such a manner that the lid portion 2 is pulled up along the upper direction. Then, as represented in FIG. 2B and FIG. 4C, the user sets such a condition that both the lid portion 2 and the coupling portion 3 are positioned on the side of the rear plane as to the plane where the operation unit 11 is present in such a manner that the coupling portion 3 climbs over the main body portion 1 in order that both the camera unit 31 and the flash-purpose LED 32 of the coupling portion 3 are faced to an opposite side (namely, back plane side) of the main display unit 21. As a result, the portable telephone 100 is suitably brought into such a condition that while the user monitors the main display unit 21, the user takes a scene picture by operating the camera unit 31 (scene photographing mode).

As previously explained, since the portable telephone 100 of this embodiment mode 1 is arranged by that one piece of the camera unit 31 is mounted on the coupling portion 3 to which both the man body portion 1 and the lid portion 2 are coupled via the first and second hinge portions 4 and 5, the portable telephone 100 can be operated in the self-portrait photographing mode and operated as the portable video phone in addition to the scene photographing mode and the others-portrait photographing mode by simply moving the lid portion 3 via the coupling portion 3 with respect to the main body portion 1.

Also, since this portable telephone 100 is arranged by that the camera portion 31 is mounted on the coupling portion 3 in such a manner that the camera unit 31 is faced from the side of the main body portion 1 to the side of the lid portion 2, mounting of the camera unit 31 can have an afford with respect to an optical axis direction of a lens of this camera unit 31. This construction of the portable telephone 100 may have an advantage that a telephotographic objective may be built in this portable telephone 100.

Construction of Second Portable Telephone 200

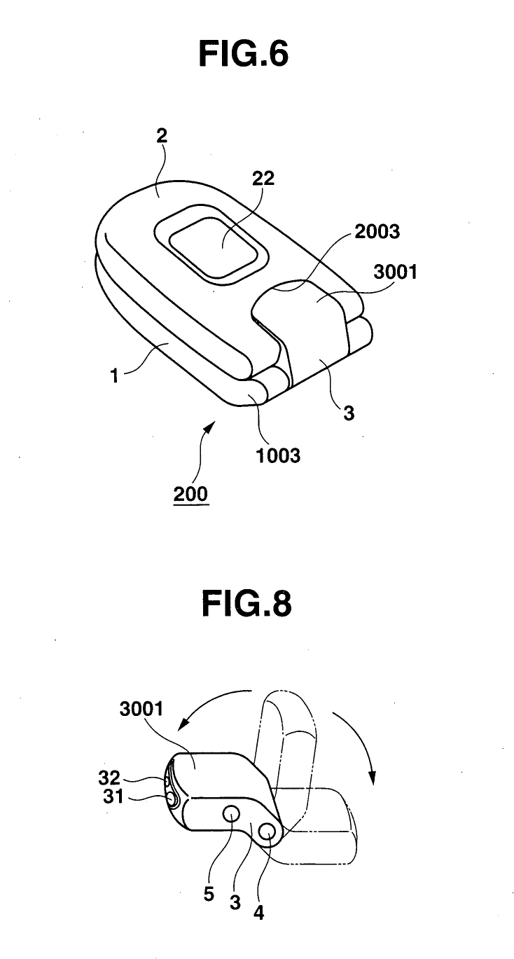

A portable telephone 200 according to an embodiment mode 2 of the present invention will now be described with reference to FIG. 6 through FIG. 9D. It should be noted that the same reference numerals shown in the basic structure of the portable telephone 100 according to the embodiment mode 1 will be employed as those for denoting the same, or similar structural members of the portable telephone 200 according to the embodiment 2, and explanations thereof are omitted. As shown in these drawings, a coupling portion 3 owns a bent extension portion 3001. This bent extension portion 3001 is bent from a second hinge portion 5 on the side of a lid portion 2 and is extended. Both a camera portion 31 and a flash-purpose LED (light emitting member) 32 are arranged on a tip plane of the bent extension portion 3001.

Then, a notch portion 2003 is formed in the lid portion 2. While a dimension of this notch portion 2003 is made larger than the dimension of the above-described notch portion 2002 of the embodiment mode 1, the notch portion 2002 is capable of storing thereinto the bent extension portion 3001 of the coupling portion 3, and also capable of passing therethrough this bent extension portion 3.

It should also be understood that a bent edge portion 1003 is formed on the main body portion 1, and is bent along a direction opposite to that of the bent edge portion 1001 employed in the above-described embodiment mode 1. Also, the above-explained bent edge portion 2001 of the embodiment mode 1 is not formed on the lid portion 2, and the lid portion 2 is overlapped on such a portion of the main body portion 1 from which the bent edge portion 1003 is eliminated, as indicated in FIG. 6 to FIG. 9A.

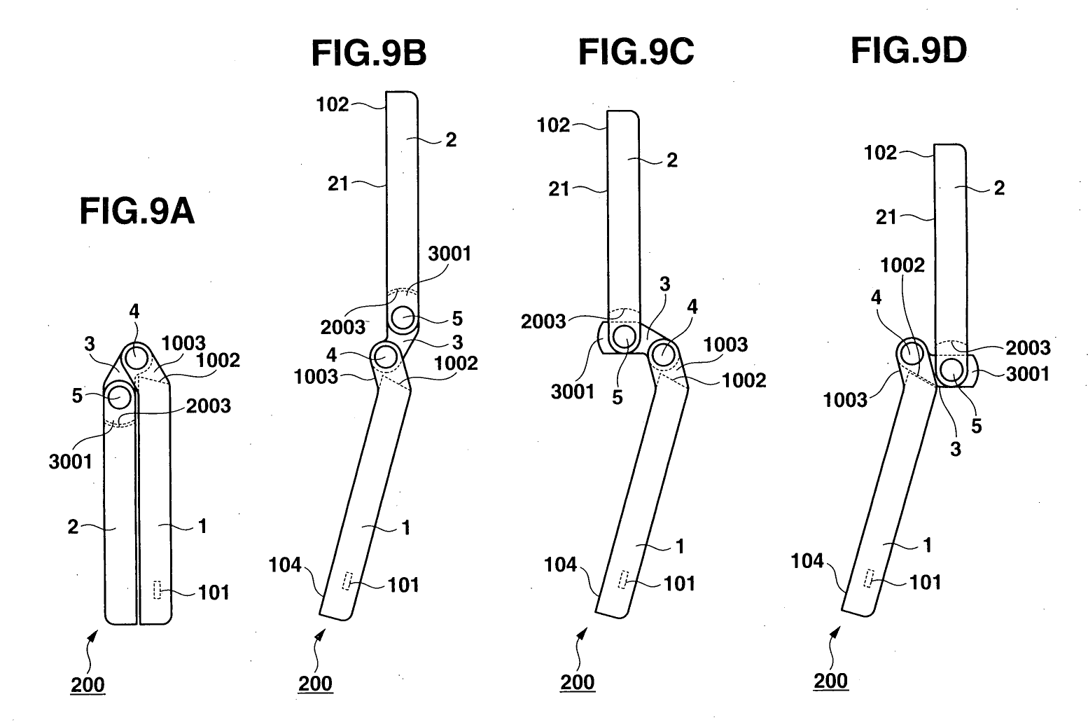

Since the portable telephone 200 is equipped with the above-explained structure, as shown in FIG. 6 and FIG. 9A, under such a folding condition of this portable telephone 200 that the lid portion 2 is overlapped on the main body portion 1, the bent extension portion 3001 of the coupling portion 3, the camera unit 31, and the flash-purpose LED 32, which are mounted on a tip plane of this bent extension portion 3001 are stored into the notch portion 2002 of the lid portion 2. As a result, both the camera unit 31 and the flash-purpose LED 32 can be protected.

Operations of Second Portable Telephone 200

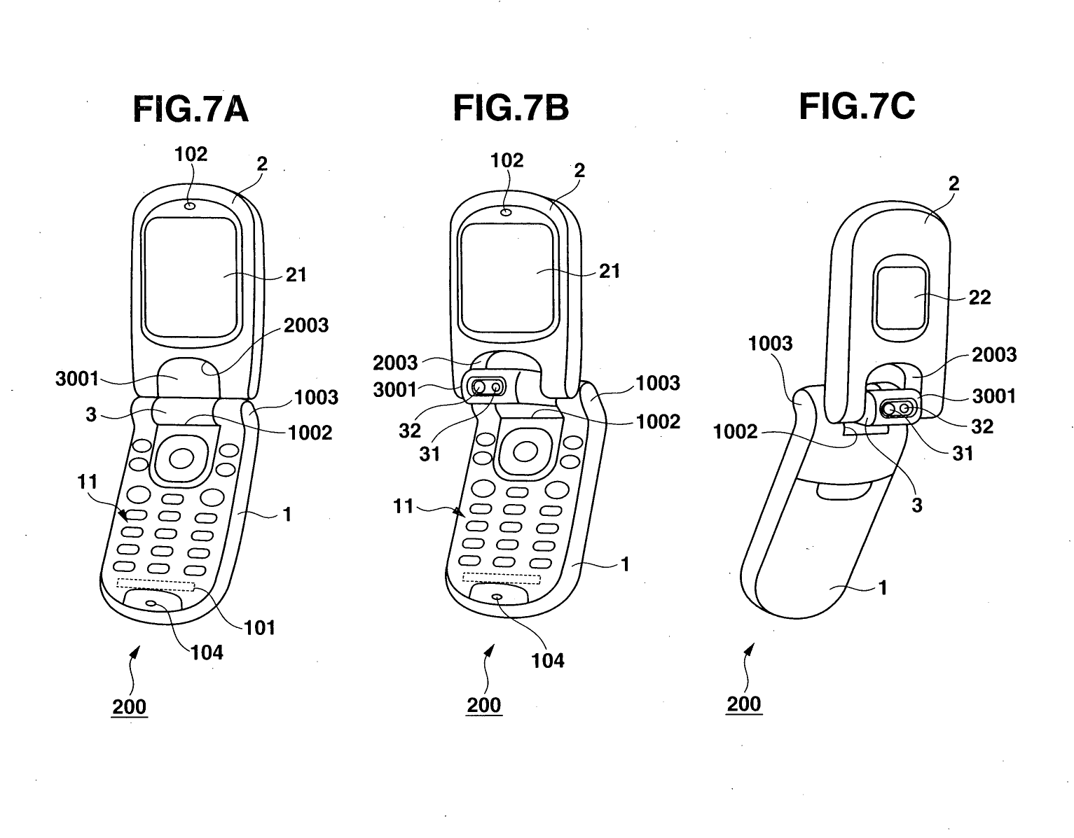

Then, the lid portion 2 is moved by the first hinge portion 4 in combination with the coupling portion 3 in the pivotable manner so as to be opened with respect to the main body portion 1 from such a condition, as shown in FIG. 6 and FIG. 9A, by operation of the user. Thus, such a condition is obtained under which, as represented in FIG. 7A and FIG. 9B, the lid portion 2 and the coupling portion 3 are located on an extension line of the main body portion 1. Even under this condition, since the storage condition for the bent extension portion 3001 of the coupling portion 3, the camera portion 31, and the flash-purpose LED 32 is maintained, it is possible to avoid that a lens (not shown in detail) of the camera unit 31 is dirtied. This dirty is caused by that the camera unit 31 is contacted to a face (skin) of the user even in the normal telephone communication process operation.

Next, while the display direction of the main display unit 21 is maintained, when the lid portion 2 is moved in such a manner that this lid portion 2 is drawn close to the user side (front plane side), the coupling portion 3 moves both the second hinge portion 5 and the first hinge portion 4 in the pivotable manner in such a manner that the coupling portion 3 is rotated along a left direction shown in FIG. 8.

In other words, as indicated in FIG. 7B and FIG. 9C, such a condition is obtained under which the lid portion 2 is positioned on the front side on the extension line of the main body portion 1, and the bent extension portion 3001 of the coupling portion 3 is faced to the front side.

As a consequence, such a condition is obtained in which the main display unit 21, the camera unit 31, and the flash-purpose LED 32 are faced to the user who holds the portable telephone 200 on his hand, namely, which may suitably constitute such a condition that while the user monitors the main display unit 31 as the view finder (monitor), the user takes a self-portrait (namely, self-portrait photographing mode). Also, this condition is suitable for a use of the portable telephone 200 as a portable video phone.

Also, from this condition, while the display direction of the main display unit 21 is maintained, the user moves the coupling portion 3 by the first hinge portion 4 in the pivotable manner in such a manner that the lid portion 2 is brought up. Then, as represented in FIG. 7C and FIG. 9D, the user sets such a condition that both the lid portion 2 and the coupling portion 3 are positioned on the side of the rear plane as to the plane where the operation unit 11 is present in such a manner that the coupling portion 3 climbs over the main body portion 1 in order that both the cameral unit 31 and the flash-purpose LED 32 mounted on the bent extension portion 3001 of the coupling portion 3 are faced to an opposite side of the main display unit 21.

As a result, the portable telephone 200 is suitably brought into such a condition that while the user monitors the main display unit 21, the user takes a scene picture and others pictures by operating the camera unit 31 (scene photographing mode and others-portrait photographing mode).

As previously explained, in accordance with the portable telephone 200 of this embodiment mode 2, the below-mentioned advantage can be obtained in addition to the operative effects similar to those of the embodiment mode 1.

That is, even in any one of a folding condition and a positioning condition, both the camera unit 31 and the flash-purpose LED 32, which are provided on the tip plane of the bent extension portion 3001 of the coupling portion 3, can be stored in the notch portion 2003 of the lid portion 2 so as to be protected. Under the folding condition, as shown in FIG. 6 and FIG. 9A, the lid portion 2 is overlapped on the main body portion 1. Under the positioning condition, as represented in FIG. 7A and FIG. 9B, both the lid portion 2 and the coupling portion 3 are positioned on the extension line of the main body portion 1.

Construction of Third Portable Telephone 400

An electric connection and an imaging operation of a portable telephone 400 according to an embodiment mode 3 will now be described in detail, to which the present invention has been applied. It should be understood that an outer view of the portable telephone 400 is similar to that of the above-described embodiment mode 1, or embodiment mode 2. It should also be noted that the same reference numerals shown in the basic structure of the portable telephones 100 and 200 according to the embodiment modes 1 and 2 will be employed as those for denoting the same, or similar structural members of the portable telephone 400 according to the embodiment 3, and explanations thereof are omitted.

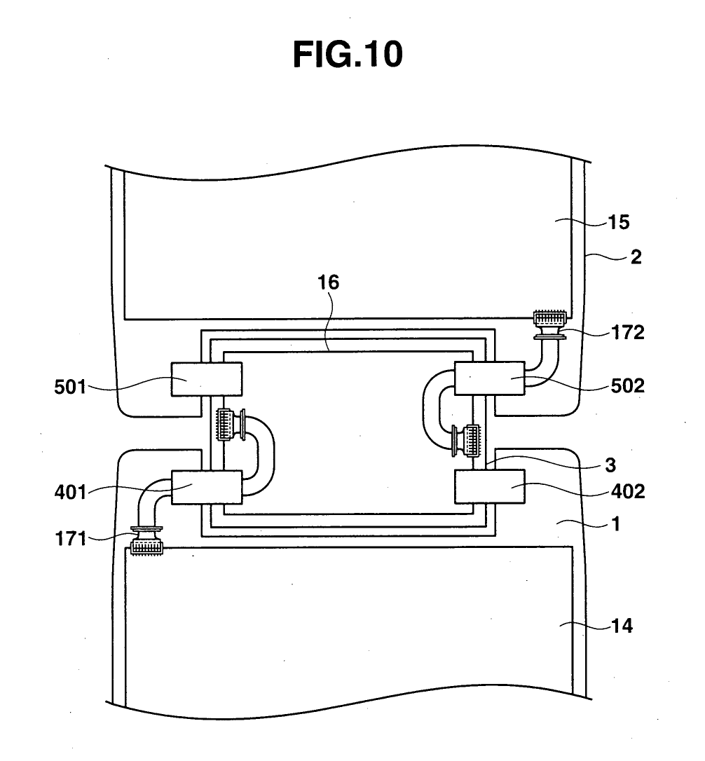

FIG. 10 is a diagram for illustratively showing an electric connection structure of electronic components provided in a space formed by coupling the main body portion 1 via the coupling portion 3 to the lid portion 2.

As indicated in FIG. 10, a main body portion board 14 is mounted inside the main body portion 1. This main body portion board 14 electrically connects the respective units of the main body portion 1 as the electronic components. Similarly, a lid portion board 15 is mounted inside the lid portion 2, and also, a coupling portion board 16 is mounted inside the coupling portion 3. A camera module 300 and the like have been mounted on the coupling portion board 16.

A first hinge portion 4 for coupling the main body portion 1 to the coupling portion 3 is constituted by a first hinge connection portion 401 and a first hinge connection portion 402, which are made in cylinder shapes respectively. Similarly, a second hinge portion 5 for coupling the lid portion 2 to the coupling portion 3 is constituted by a second hinge connection portion 501 and a second hinge connection portion 501.

Flexible cables 171 and 172 correspond to flexible printed-circuit boards (FPC) in which an electric conductive pattern has been formed on, for example, a plastic film (polyimide, or polyester) having flexibility. While the flexible cables 171 and 172 may be bent, folded, and may constitute movable wiring lines, these flexible cables 171 and 172 electrically connect one terminals thereof to the other terminals thereof.

The flexible cable 171 is employed so as to connect one terminal of the main body portion board 14 to one terminal of the coupling portion board 16, while this flexible cable 171 is dragged inside the first hinge connection portion 401. Similarly, the flexible cable 172 is employed so as to connect one terminal of the lid portion board 15 to one terminal of the coupling portion board 16, while this flexible cable 172 is dragged inside the second hinge connection portion 502.

Then, in the case that both the main body portion 1 and the coupling portion 3 are moved in a pivotable manner, and both the lid portion 2 and the coupling portion 3 are moved in a pivotable manner, since the flexible cables 171 and 172 are relaxed, or bent, the boards to be connected are electrically connected to each other by these flexible cables 171 and 172.

Electronic Internal Arrangement of Portable Telephone 400

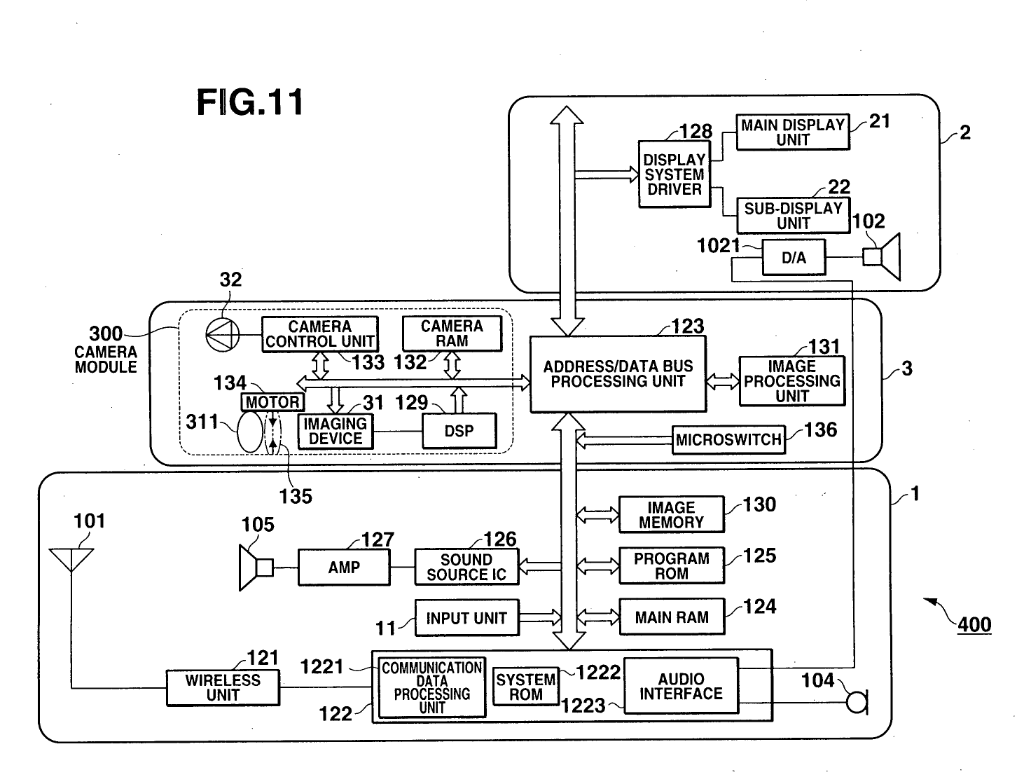

FIG. 11 schematically shows an electronic internal arrangement of the portable telephone 400 according to the embodiment mode 3. The main body unit 1 is equipped with an antenna unit 101, a wireless unit 121, a control unit 122, a speaker 105, an AMP (amplifier) 127, a sound source IC 126, an operation unit (input unit) 11, an image memory 130, a program ROM 125, a main RAM 124, and also, a microphone 104.

The lid portion 2 is equipped with a display system driver 128, a main display unit 21, a sub-display unit 22, a D/A (digital-to-analog) converting unit 1021, and a speaker 102.

The coupling portion 3 is equipped with a camera module 300, an address/data bus processing unit 123, an image processing unit 131, and a microswitch 136.

The camera module 300 corresponds to a module having a function of a digital camera, which outputs a photographed image as image data. The camera module 300 is provided with a flash-purpose LED (light emitting member) 32, a camera control unit 133, a camera RAM 132, a lens 311, a motor 134, a shutter 135, an image capturing device 31, and a DSP 129.

The camera control unit 133 reads various sorts of application programs including a system program and an image processing program, which have been stored in an internal ROM thereof. Then, the camera control unit 133 expands the read programs to a work memory (will be described later) formed in the camera RAM 132, and controls the respective units provided in the camera module 300, the image processing unit 131, and the display system driver 128 in accordance with these programs and an instruction issued from the control unit 122.

The camera RAM 132 forms a memory area which temporarily stores thereinto various sorts of data, and image data which have been expanded to a buffer memory (not shown) and have been imaged, while the camera control unit 133 executes various sorts of processing operations.

The motor 134 corresponds to a stepper motor, a piezoelectric motor, or the like. The motor 134 moves the lens 311 in order to adjust a size (field angle) of a photographic object focused onto the image capturing device 31, or so as to perform a focusing control.

The shutter 135 adjusts a dimension of an aperture portion of the lens 311 in order to control a light amount of a photographic object which is exposed to the image capturing device 31.

The image processing unit 131 executes various sorts of image adjusting operations, image converting operations, or compressing/decoding process operations of image data. In the various sorts of image adjusting operations, this image processing unit 131 performs a luminance control operation, a white balance control operation, and the like based upon image data such as YUV signals entered from the DSP 129. In the image converting operation, the image processing unit 131 converts the format of the image data into such a format which is standardized based upon GIF, JPEG, TIFF, BMP etc.

The microswitches 136 are switches which are provided inside both the first hinge connection portion 402 and the second hinge connection portion 501. The respective conditions shown in FIG. 1 to FIG. 1B (FIG. 4A to FIG. 4C), and FIG. 6 to FIG. 7C (FIG. 9A to FIG. 9D) may be detected by checking combinations of signals detected from these microswitches 136.

The image memory 130 is employed so as to store thereinto various image data such as an image photographed by the camera module 300, and an image acquired by a data communication. This image memory 130 is arranged by a non-volatile memory, for example, a flash memory. The D/A converting unit 1021 D/A-converts a digital voice signal derived from the audio interface 12 into an analog voice signal which is supplied to the speaker 102.

Sequential Operation of Photographing Modes by Portable Telephone 400

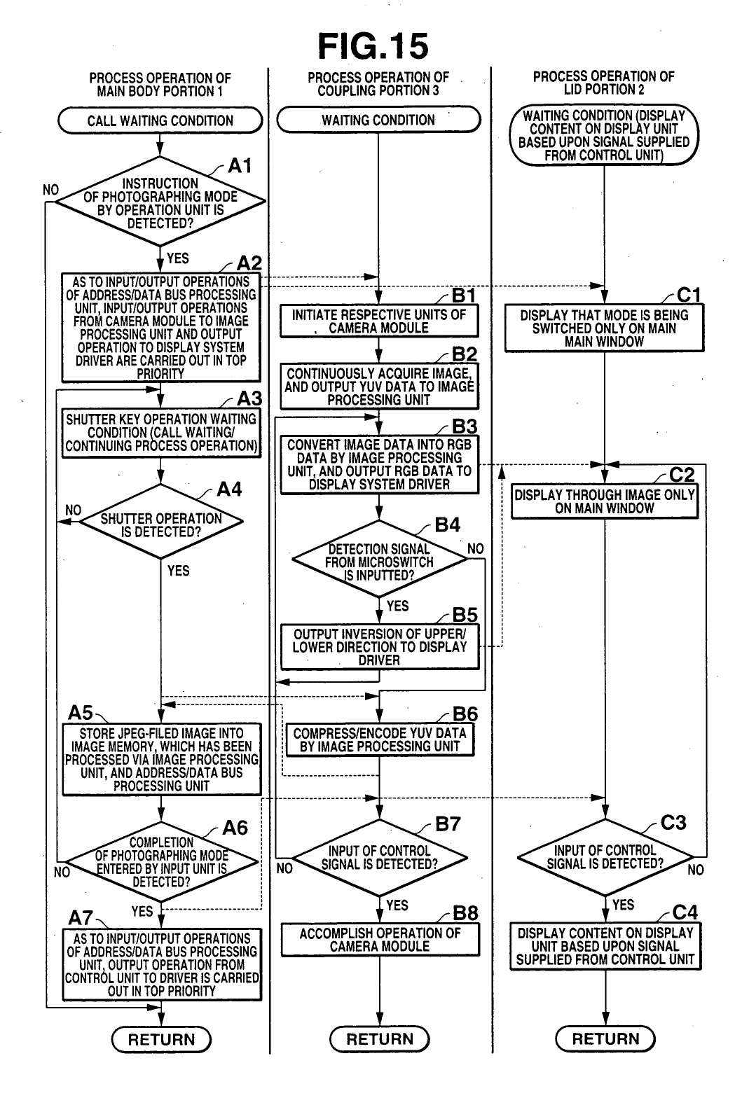

Referring now to a flow chart of FIG. 15, a description is made of a sequential operation of the portable telephone 400 according to this embodiment mode 3 after the operation mode thereof is advanced to a photographing mode until the photographing mode is accomplished.

In this flow chart, first of all, the control unit 122 detects an instruction of a photographing mode instructed by the operation unit (input unit) 11 (step A1). When the control unit 122 does not detect the instruction of the photographing mode (“NO” in step A1), the sequential operation is directly accomplished.

In the case that the control unit 122 detects the instruction for advancing the operation mode to the photographing mode (“YES” in step A1) in this step A1, the control unit 122 instructs the address/data bus processing unit 123 to input/output data in such a manner that data is inputted/outputted from the camera module 300 to the image processing unit 131 in a top priority, and also, data is outputted from the image processing unit 131 to the display system driver 128 in a top priority (step A2). Then, the control unit 122 sends an instruction to the camera control unit 133 so as to initiate the respective internal units of the camera module 300, so that the operation mode thereof is advanced to a photographing mode (step B1). Further, the control unit 122 instructs the display system driver 128 so as to display such an image that the operation mode is being switched to the photographing mode on the display screen of either the main display unit 21 or the sub-display unit 22 (step C1).

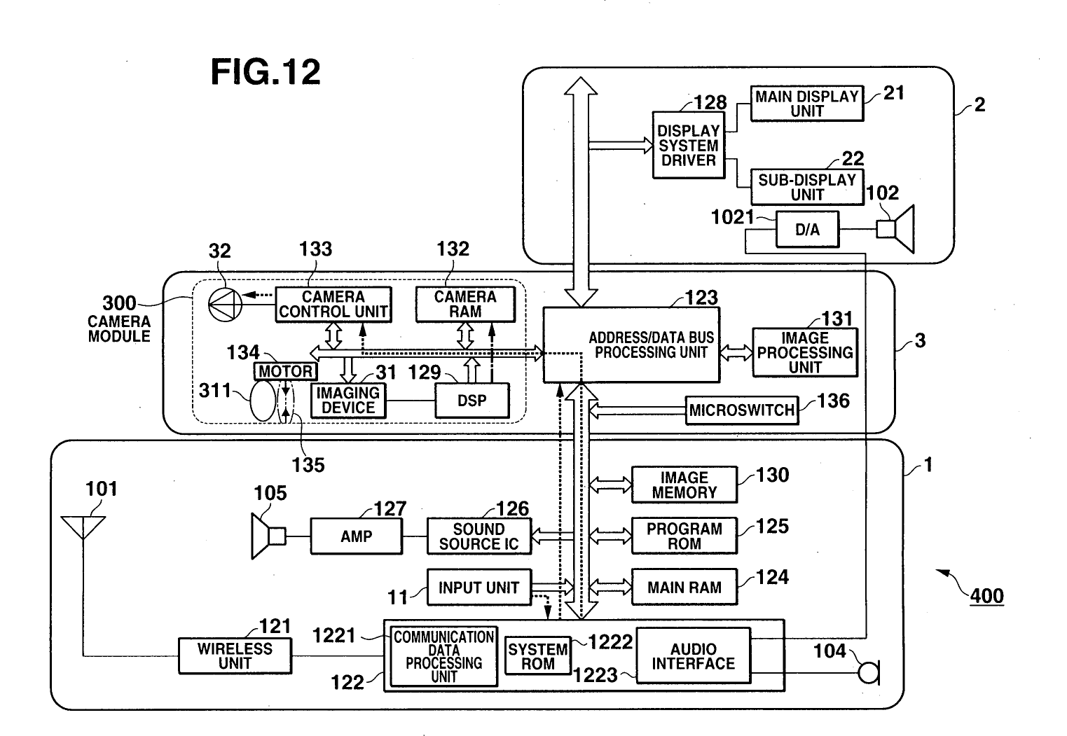

At this time, flows of the control signals produced in the above-described steps A1 and A2 are represented in FIG. 12. FIG. 12 is a schematic diagram which is made by indicating control signals until the instruction is transmitted to the camera control unit 133 so as to initiate the camera module 300 in the internal circuit arrangement of the portable telephone 400 shown in FIG. 11.

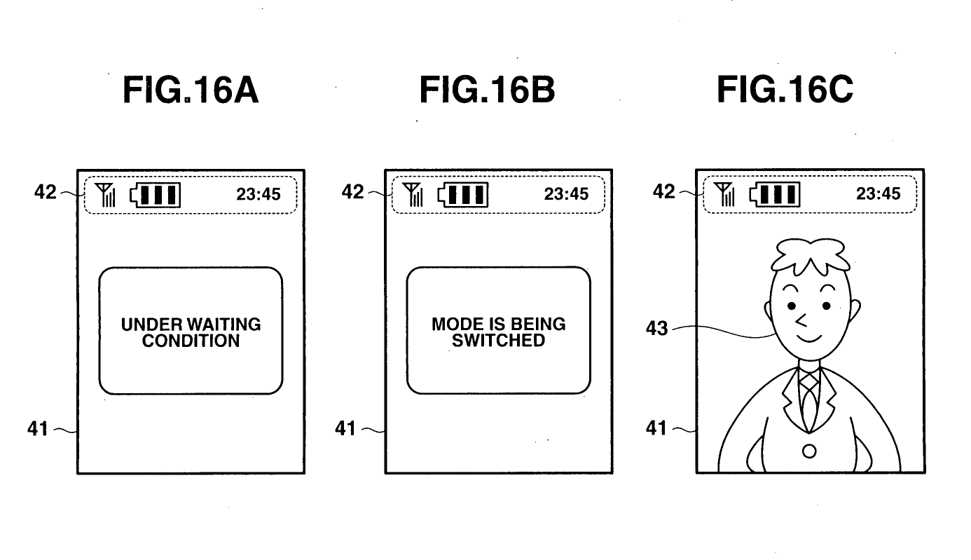

FIG. 16A and FIG. 16B represent display modes of the display screens on either the main display unit 21 or the sub-display unit 22 under the above-explained conditions.

FIG. 16A is a diagram for indicating a display screen corresponding to a waiting condition as to a process operation and a telephone call issued from a user, for instance, photographing operation/image editing operation/various sorts of setting operations. The display screen is arranged by overlapping a transmission type sub-window area 42 on a main window area 41 corresponding to the entire display screen. In this transmission type sub-window area 42, display control operations are carried out based upon received electromagnetic wave information, remaining battery power information, and time information, which are transmitted in a constant time period from the control unit 122 to the display system driver 128.

FIG. 16B is a diagram for indicating such a condition that the operation mode is being switched to the photographing mode in the above-described step C1 on the main window area 41.

Next, in response to the instruction for instructing the operation mode of the camera module 300 to the photographing mode, the control unit 122 initiates the respective units of the camera module 300 (step B1), and thereafter, the camera control unit 133 outputs the image data (YUV signals) which has been photographed by the image capturing device 31 and then has been converted by the DSP 129 to the image processing unit 131 (step B2). The camera control unit 133 outputs image data whose image format has been converted into the display-purpose format such as RGB format by this image processing unit 131 to the display system driver 128 (step B3), and displays this RGB-formatted image on the main window area 41 (step C2).

FIG. 16C is a diagram for indicating a through image in such a case that photographed images are displayed in real time on the main window area 41 in the step C2.

On the display screen, a photographic object 43 which has been photographed by the image capturing device 31 is displayed on the main window area 41, on which the transmission sub-window area 42 is displayed in the transmission mode. Under this condition, in the case that a transition from the condition shown in FIG. 2A (FIG. 4B) to the condition indicated in FIG. 2B (FIG. 4C) is detected by checking signals derived from the microswitches 136; or another transition from the condition indicated in FIG. 7B (FIG. 9C) to the condition represented in FIG. 7C (FIG. 9D) is detected by checking signals derived from the microswitches 136; and vice versa (“YES” in step B4), the camera control unit 133 issues a control instruction to the display system driver 128 in such a manner that upper/lower directions are inverted (step B5).

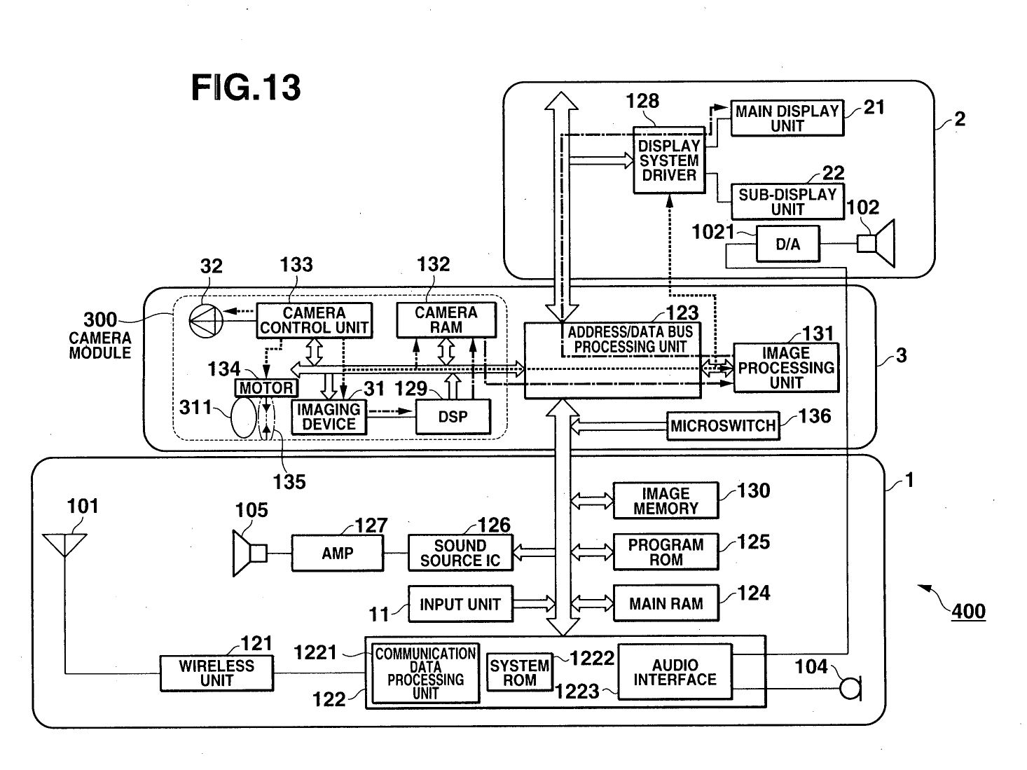

In this connection, FIG. 13 shows flows of the control signal and flows of the image signals in the above-explained steps B1 to B5, and step C2.

FIG. 13 is a diagram for representing both the control signals (indicated by dot lines) and the image signals (indicated by dot and dash lines), capable of realizing a view finder function in such a way that the respective units of the camera module 300 are initiated and controlled in response to the instructions of the camera control unit 133, so that the image photographed by the image capturing device 31 is displayed as the through image on the main window area 41.

As indicated in FIG. 13, the process operation for realizing the view finder function is carried out by such a manner that the camera control unit 133 controls the respective circuit units employed in the lid portion 2 and the coupling portion 3. During this process operation capable of realizing the view finder function, the control unit 122 is brought into a waiting condition for waiting operation of the shutter key (step A3), and the control operations by this control unit 122 can be concentrated to other process operations such as a data communication process operations, or a telephone call process operation except for the display control operation of the transmission sub-window area 42. As a result, the appliance of the portable telephone 400 can be effectively operated.

In the case that the operation of the shutter key of the operation unit (input unit) 11 is detected after the above-explained step A3 (“YES” in step A4), the control unit 12 transmits a depression signal of the shutter button provided in the operation unit (input unit) 11 to the camera control unit 133.

Upon receipt of this depression signal, the camera control unit 133 controls the image processing unit 131 to perform the converting process operation and the compressing/coding process operation as to the image data (YUV signals) photographed by the image capturing device 31 into the predetermined image format thereof (step B6), and then, transmits the processed image data to the control unit 122.

Then, the control unit 122 stores the image data transmitted from the image processing unit 131 into the image memory 130 (step A5), and is brought into a waiting condition in such a manner that the control unit 122 executes the process operations defined from the step A3 to the step A5 until a completion of the photographing mode by the operation unit (input unit) 11 is detected (step A6).

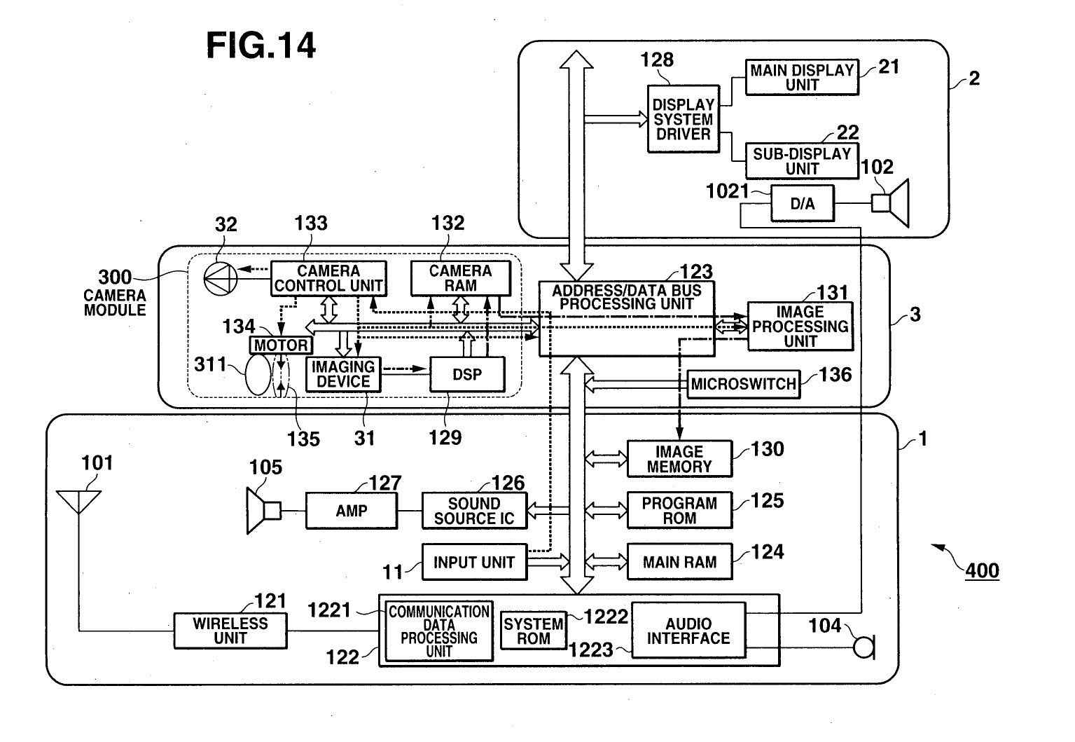

FIG. 14 shows flows of the control signals and flows of the image signals in the steps A4, A5, and the step B6.

FIG. 14 is a diagram for showing operations of the portable telephone 400, in which an image which has been photographed by the image capturing device 31 in response to a depression of the shutter button is converted into such an image having a predetermined image format by the image processing unit 131, and thereafter, the format-converted image is stored in the image memory 130.

As a consequence, the control unit 122 may merely execute such a process operation that the control unit 122 transmits a signal to the camera control unit 133, and then stores an image processed by the camera control unit 133 into the image memory 130, and the transmitted signal is produced by depressing the shutter button while the user confirms the photographic object 34 by using the view finder function.

In the step A6, when the completion of the photographing mode is detected (“YES” in step A6), the control unit 122 outputs control signals as to the completion of the photographing mode to both the camera control unit 133 and the display system driver 128, and instructs the address/data bus processing unit 123 to input/output the data derived from the control unit 122 into/from the own address/data bus processing unit 123 in a top priority (step A7), and then, accomplishes the process operation.

Also, the camera control unit 133 detects the input of the control as to the photographing mode completion (“YES” in step B7), so that the camera control unit 133 accomplishes the operations of the respective units employed in the camera module 300 (step B8).

When the display system driver 128 receives the control signal as to the photographing mode completion, the display system driver 128 switches an image which is displayed on the main window area 41 to the signal inputted from the control unit 122 (step C4), and then, accomplishes the process operation.

As previously described, the portable telephone 400 of this embodiment mode 3 is equipped with the camera control unit 133 which controls to display the image photographed in the camera module 300 on either the main display unit 21 or the sub-display unit 22, and on the other hand, this portable telephone 400 is provided with the control unit 122 for controlling the wireless unit 121 in the main body portion 1. As a result, this portable telephone 400 can quickly execute the telephone call waiting process operation by the wireless manner, the data communication process operation, and the photographing process operation, while these process operations do not give adverse influences to each other, and can reduce the noise which gives the adverse influences to the wireless communication when the photographing operation is carried out.

Also, since the address/data bus processing unit 123 for controlling the data communication operation is provided between the camera module 300, the main display unit 21, or the sub-display unit 22, and the main body portion 1, when the through image is photographed, there is no possibility that the through image data is entered into the main body portion 1. More specifically, even under such a condition that the image data is continuously transmitted via the data bus provided in the flexible printed board 172 shown in FIG. 10 to either the main display unit 21 or the sub-display unit 22, the data bus provided in the flexible printed board 171 is not occupied by the image data. As a result, the adverse influence given to the processing operation executed in the main body portion 1 can be reduced.

Furthermore, the data communication of the image data from the camera module 300 to either the main display unit 21 or the sub-display unit 22 during the photographing operation is carried out in a top priority, as compared with the data communication from the main body portion 1. As a result, even in such a case that the main display unit 21 is utilized as the above-explained view finder, the image display operation can be carried out in a smooth manner.

Construction of Fourth Portable Telephone 500

A description is made of a portable telephone 500 according to an embodiment mode 4, to which the present invention has been applied.

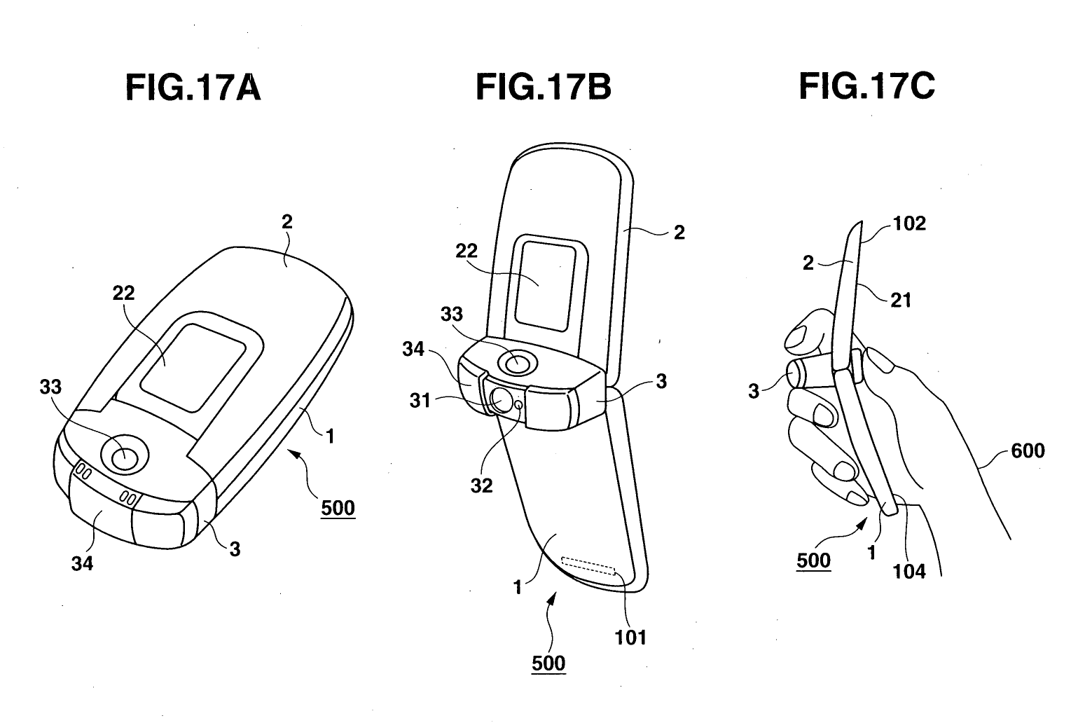

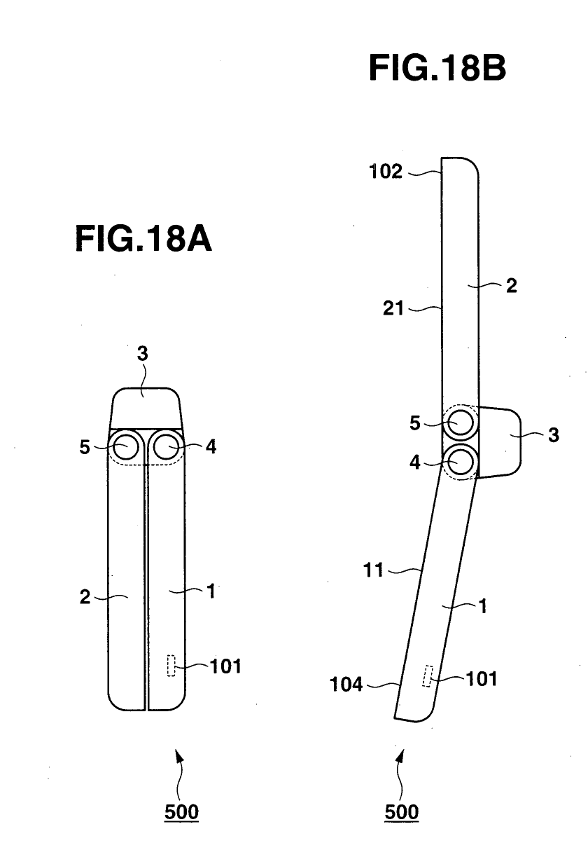

In outer views shown in FIG. 17A to FIG. 18B, reference numeral 1 shows a main body, reference numeral 2 represents a lid portion, reference numeral 3 indicates a coupling portion, reference numeral 4 shows a first hinge portion, and reference numeral 5 denotes a second hinge portion.

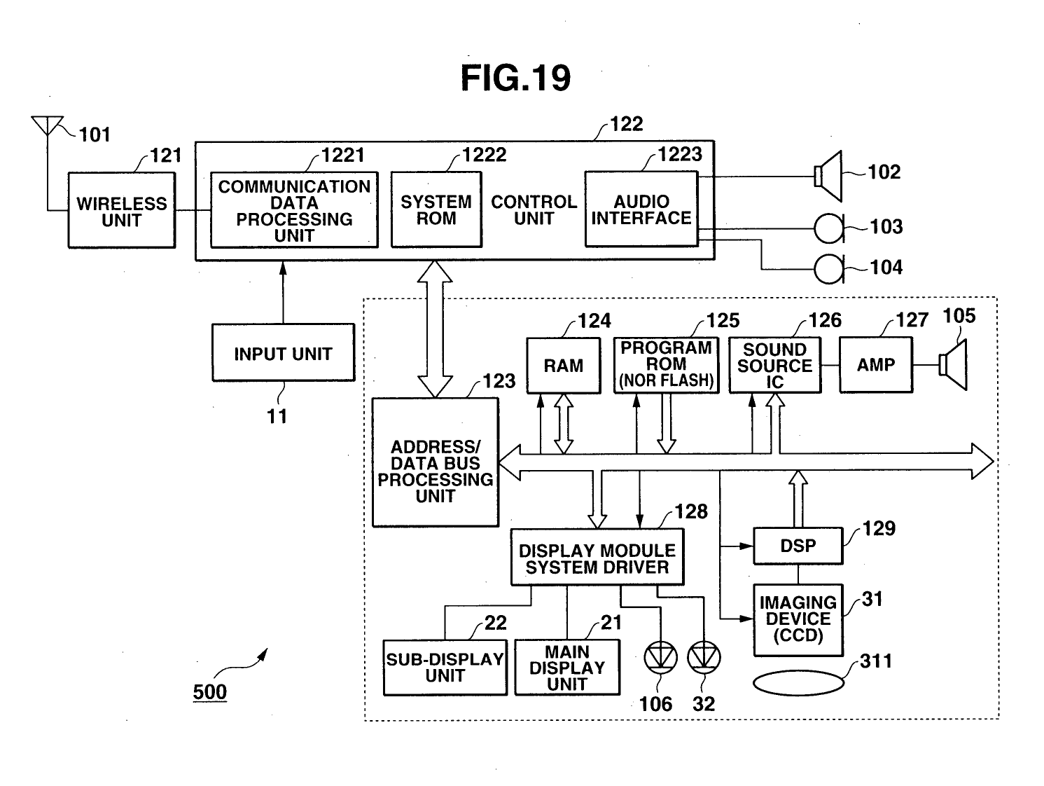

The main body portion 1 is equipped with an operation unit (input unit of FIG. 19) 11, a built-in type antenna 101, and a microphone 104. The operation unit 11 is constituted by various sorts of input keys and a ten-numeral enter key, and these input keys contain a camera key, and the like. Under such a condition that the portable telephone 500 is not operated as a telephone, as indicated in FIG. 17A and FIG. 18A, the lid portion 2 is overlapped on the main body portion 1 along a longitudinal direction on a plane having the operation unit 11 of this main body portion 1.

Both the main body portion 1 and the lid portion 2 are assembled in a pivotable manner via the coupling portion 3 on one edge side of this overlapped condition along the longitudinal direction.

The lid portion 2 owns such a dimension capable of covering the main body portion 1, and is equipped with a main display unit 21 (see FIG. 19) on the side of such a plane on which the operation unit 11 of the main body portion 1 is provided, and also, is equipped with a sub-display unit 22 on the side of a rear plane, as shown in FIG. 17A and FIG. 17B.

As shown in FIG. 18B, this coupling portion 3 is coupled by the first hinge portion 4 in a pivotable manner with respect to an edge portion of the main body portion 1, and further, is coupled by the second hinge portion 5 in a pivotable manner with respect to an edge portion of the lid portion 2.

As represented in FIG. 17B, both a camera unit 31 and a flash-purpose LED 32 are provided on a tip plane of this coupling portion 3, which is located opposite to the first and second hinge portions 4 and 5. Then, a shutter button 33 is provided on an upper plane of the coupling portion 3. Also, a lens barrier 34 for opening and closing the camera portion 31 is assembled to the tip plane of the coupling portion 3.

Electronic Processing Units of Fourth Portable Telephone 500

FIG. 19 is a schematic block diagram for showing communication/image/control processing units employed in the above-described portable telephone 500.

In this drawing, a wireless unit 121 corresponds to a circuit unit which is electrically connected to the built-in antenna 101, and drives/controls the built-in antenna 101. The wireless unit 121 performs a communication processing operation containing a modulation processing operation and a terminal authentication processing operation with respect to a wireless signal produced based upon a wireless communication system employed by an external communication service providing company. As the wireless communication system, for example, CDMA, PDC, and GSM communication systems are employed by communication service providing companies.

A control unit 122 controls an entire unit of the circuit of this portable telephone 500, and also, controls WWW (world wide web) connections established via communication service providing companies. The control unit 122 contains a communication data processing unit 1221, a system ROM (read-only memory) 1222, and an audio interface 1223. The communication data processing unit 1221 contains a voice decoding/coding process circuit, a packet data producing circuit, and a packet data restoring circuit, which are not shown in FIG. 19. This communication data processing unit 1221 executes a data processing operation in accordance with a communication protocol employed by a communication service providing company. A basic system for controlling a main portion of this portable telephone 500 has been stored in the system ROM 1222. The audio interface 1223 inputs/outputs a voice signal which is processed in the communication data processing unit 1221. A speaker 101, a recording microphone 103, and a microphone 104, which are provided in this portable telephone 500, are connected to the audio interface 1223.

An address data bus processing unit 123 controls and manages input/output timing of data with respect to the control unit 122 and peripheral circuits (namely, circuits surrounded by broken line of FIG. 19). A RAM (random access memory) 124 stores thereinto various sorts of data, for instance, address directory data which contain telephone numbers, mail data and Internet address which are used in network connections, image data acquired by an image capturing device (camera unit) 31, and the like. A program ROM 125 has previously stored thereinto various sorts of application programs which contain an image processing program. A sound source IC 126 stores thereinto waveforms of notification sounds, and also outputs melodies and the like as the notification sounds. An amplifier 127 amplifies an output signal derived from the sound source IC 126. A notification-purpose speaker 105 provided in the portable telephone 500 reproduces notification sounds.

A display module system driver 128 drives the main display unit 21, the sub-display unit 22, a flash-purpose LED 107, and a notification-purpose LED (light emitting diode) 106, which are provided on the portable telephone 500. The image capturing device (camera unit) 31 is constituted by a CCD (charge-coupled device) and the like, onto which an image of a photographic object is focused by a lens 311 of this image capturing device 31. A DSP (digital signal processor) 129 is to process an image signal derived from this image capturing device (camera unit) 31.

Operations of Fourth Portable Telephone 500

As previously explained, in the folding type portable telephone 500 of the embodiment mode 4, the main body portion 1 is coupled to one edge side of the coupling portion 3 by the first hinge portion 4, and the lid portion 2 is coupled to the one edge side by the second hinge portion 4. Then, the camera unit 31 is faced to the tip plane of the coupling portion 3, which is located opposite to the first and second hinge portions 4 and 5.

As a consequence, from such a folding condition shown in FIG. 17A and FIG. 18A that the lid portion 2 is overlapped on the main body portion 1, both the main body portion 1 and the lid portion 2 are moved upwardly and downwardly by the first and second hinge portions 4 and 5 in the pivotable manner with respect to the coupling portion 3. Then, as represented in FIG. 17B and FIG. 18B, since the main body portion 1 and the lid portion 2 are opened, this portable telephone 500 is brought into such a proper condition that while the user holds the portable telephone 500 by his hand, the user can perform the photographing operation by using the camera portion 31.

In other words, as shown in FIG. 17A, the lens barrier 34 of the coupling portion 3 is slid so as to open the camera unit 31. Thereafter, as shown in FIG. 17C, under the condition that the coupling portion 3 which is projected from the main body 1 and the lid portion 2 toward the front direction is positioned on a middle finger of one hand of the user, and a thumb of this hand touches the rear side of the coupling portion 3, if the user depresses the shutter button 32 by using an index finger while the user observes the main display portion 21 as the view finder (monitor), then the user can perform the photographing operation by the camera unit 31.

As previously explained, since the portable telephone 500 of this embodiment mode 4 is arranged by the coupling portion 3 to which both the man body portion 1 and the lid portion 2 are coupled via the first and second hinge portions 4 and 5 on one edge side thereof, and by the camera unit 3 provided on the other edge side thereof, the user can perform the photographing operation while the user steadily sandwiches the coupling portion 3 by his hand. As a result, the user can perform the photographing operation while suppressing movement of his hand, so that the manipulations of the camera unit 3 can be improved in the photographing mode.

Also, under such a condition that the main body portion 1 and the lid portion 2 are folded, since the camera portion 31 is provided on the coupling portion 3 located on the extension line thereof, the portable telephone 500 can be made compact.

Then, the portable telephone 500 is arranged in such a manner that the camera portion 31 is provided to be faced to the other edge side of the coupling portion 3 to which both the main body portion 1 and the lid portion 2 are coupled via the hinge portions on one edge side mounting of the camera unit 31 can have an afford with respect to an optical axis direction of a lens of this camera unit 31. This construction of the portable telephone 500 may have an advantage that a telephotographic objective may be built in this portable telephone 500.

Furthermore, as previously explained, since the user steadily sandwiches the coupling portion 3 by his hand to hold the portable telephone 500, the user can perform the photographing operation while suppressing the movement of his hand. As a result, this portable telephone 500 can be advantageously applied to an employment of high performance of cameras.

Construction of Fifth Portable Telephone 600

An electric connection and an imaging operation of a portable telephone 600 for coupling a main body portion 1 and a lid portion 2 via a coupling portion 3, according to an embodiment mode 5 will now be described in detail, to which the present invention has been applied. It should be noted that the same reference numerals shown in the basic structure of the portable telephone 500 according to the embodiment mode 4 will be employed as those for denoting the same, or similar structural members of the portable telephone 600 according to the embodiment 5, and explanations thereof are omitted.

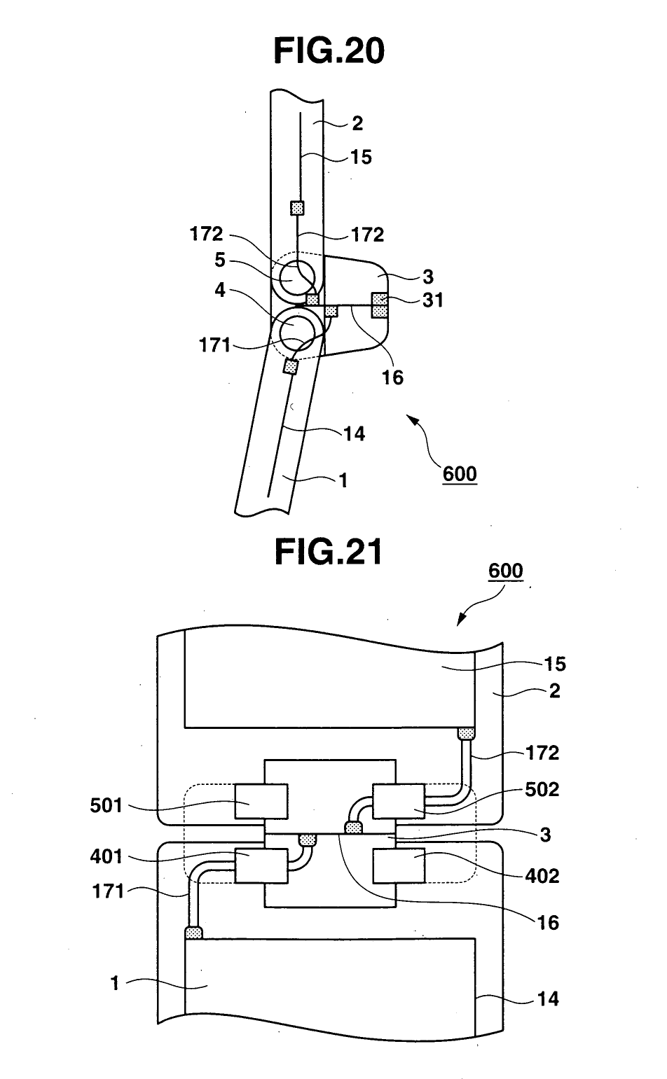

FIGS. 20 and 21 are diagrams for illustratively showing an electric connection structure of electronic components provided in a space formed by coupling the main body portion 1 via the coupling portion 3 to the lid portion 2. FIG. 20 is a side view for showing a coupling portion of the portable telephone 600. FIG. 21 is a front view for showing the coupling portion.

As represented in FIG. 20 and FIG. 21, a main body portion board 14 is mounted inside the main body portion 1. This main body portion board 14 electrically connects the respective units of the main body portion 1 as the electronic components. Similarly, a lid portion board 15 is mounted inside the lid portion 2, and also, a coupling portion board 16 is mounted inside the coupling portion 3. A camera module 300 and the like have been mounted on the coupling portion board 16.

A first hinge portion 4 for coupling the main body portion 1 to the coupling portion 3 is constituted by a first hinge connection portion 401 and a first hinge connection portion 402, which are made in cylinder shapes respectively. Similarly, a second hinge portion 5 for coupling the lid portion 2 to the coupling portion 3 is constituted by a second hinge connection portion 501 and a second hinge connection portion 501.

Flexible cables 171 and 172 correspond to such cables that wiring lines are formed on flexible boards, and these flexible cables 171 and 172 are realized as such flexible printed-circuit boards (FPC) in which an electric conductive pattern has been formed on, for example, a plastic film (polyimide, or polyester) having flexibility. While the flexible cables 171 and 172 may be bent, folded, and may constitute movable wiring lines, these flexible cables 171 and 172 electrically connect one terminals thereof to the other terminals thereof.

The flexible cable 171 is employed so as to connect one terminal of the main body portion board 14 to one terminal of the coupling portion board 16, while this flexible cable 171 is dragged inside the first hinge connection portion 401. Similarly, the flexible cable 172 is employed so as to connect one terminal of the lid portion board 15 to one terminal of the coupling portion board 16, while this flexible cable 172 is dragged inside the second hinge connection portion 502.

Then, in the case that both the main body portion 1 and the coupling portion 3 are moved in a pivotable manner, and both the lid portion 2 and the coupling portion 3 are moved in a pivotable manner, since the flexible cables 171 and 172 are relaxed, or bent, the boards to be connected are electrically connected to each other by these flexible cables 171 and 172.

Electronic Internal Arrangement of Portable Telephone 600

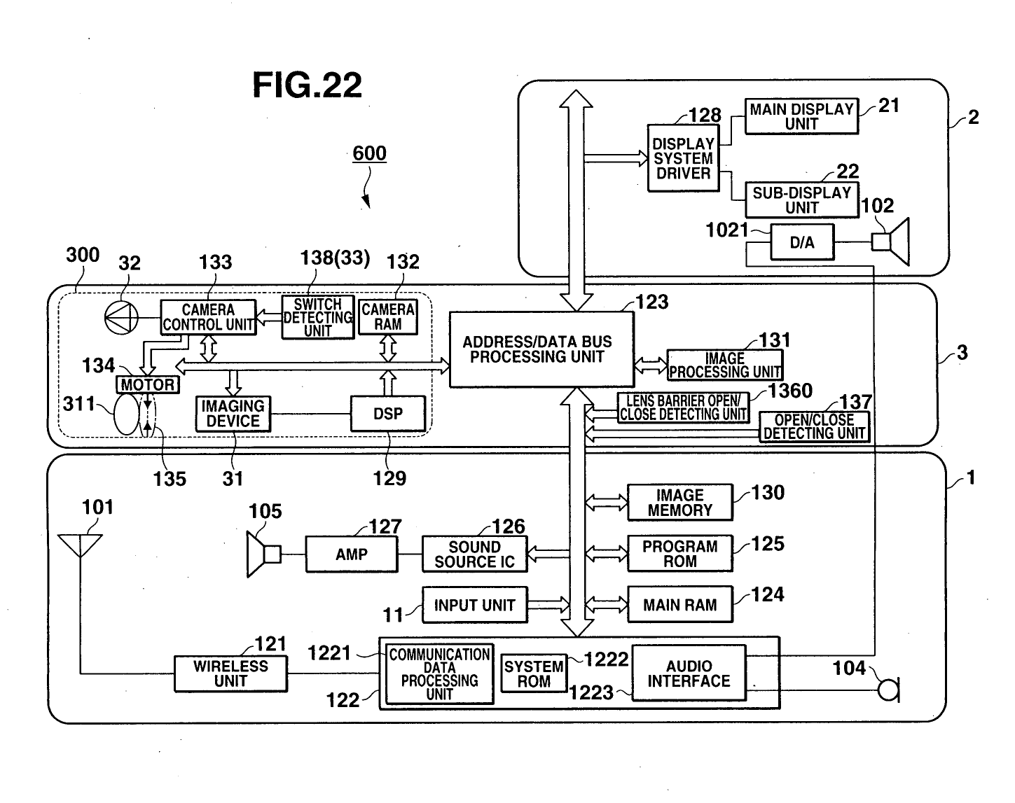

FIG. 22 schematically shows an electronic internal arrangement of the portable telephone 600 according to the embodiment mode 5.

The main body unit 1 is equipped with an antenna unit 101, a wireless unit 121, a control unit 122, a speaker 105, an AMP (amplifier) 127, a sound source IC 126, an operation unit (input unit) 11, an image memory 130, a program ROM 125, a main RAM 124, and also, a microphone 104. The lid portion 2 is equipped with a display system driver 128, a main display unit 21, a sub-display unit 22, a D/A (digital-to-analog) converting unit 1021, and a speaker 102. The coupling portion 3 is equipped with a camera module 300, an address/data bus processing unit 123, an image processing unit 131, a lens barrier open/close detecting unit 1360, and an open/close detecting unit 137.

The camera module 300 corresponds to a module having a function of a digital camera, which outputs a photographed image as image data. The camera module 300 is provided with a flash-purpose LED (light emitting member) 32, a camera control unit 133, a switch detecting unit 138, a camera RAM 132, a lens 311, a motor 134, a shutter 135, an image capturing device 31, and a DSP 129.

The camera control unit 133 reads various sorts of application programs including a system program and an image processing program, which have been stored in an internal ROM thereof. Then, the camera control unit 133 expands the read programs to a work memory (will be described later) formed in the camera RAM 132, and controls the respective units provided in the camera module 300, the image processing unit 131, and the display system driver 128 in accordance with these programs and an instruction issued from the control unit 122.

The camera RAM 132 forms a memory area which temporarily stores thereinto various sorts of data, and image data which have been expanded to a buffer memory (not shown) and have been imaged, while the camera control unit 133 executes various sorts of processing operations.

The motor 134 corresponds to a stepper motor, a piezoelectric motor, or the like. The motor 134 moves the lens 311 in order to adjust a size (field angle) of a photographic object focused onto the image capturing device 31, or so as to perform a focusing control.

The shutter 135 adjusts a dimension of an aperture portion of the lens 311 in order to control a light amount of a photographic object which is exposed to the image capturing device 31. The switch detecting unit 138 corresponds to such a switch which may discriminate a half-depression status from an actual depression status as a depression status of the shutter button 32, and then, may output a discrimination switch signal.

The image processing unit 131 executes various sorts of image adjusting operations, image converting operations, or compressing/decoding process operations of image data. In the various sorts of image adjusting operations, this image processing unit 131 performs a luminance control operation, a white balance control operation, and the like based upon image data such as YUV signals entered from the DSP 129. In the image converting operation, the image processing unit 131 converts the format of the image data into such a format which is standardized based upon GIF, JPEG, TIFF, BMP etc.

The lens barrier open/close detecting unit 1360 corresponds to a microswitch capable of detecting open/close statuses of the lens barrier 34. The lens barrier open/close detecting unit 1360 detects either an open status or a close status of the lens barrier 34, and then, outputs a detection signal to the control unit 122.

The open/close detecting unit 137 corresponds to such microswitches provided inside the first hinge connection portion 402 and the second hinge connection portion 501. This open/close detecting unit 137 detects open/close statuses of both the main body portion 1 and the lid portion 2 based upon a relative angle between the main body portion 1 and the lid portion 2 (refer to FIG. 18A for indicating close status and FIG. 18B for representing open status).

The image memory 130 is employed so as to store thereinto various image data such as an image photographed by the camera module 300, and an image acquired by a data communication. This image memory 130 is arranged by a non-volatile memory, for example, a flash memory.

The D/A converting unit 1021 D/A-converts a digital voice signal derived from the audio interface 12 into an analog voice signal which is supplied to the speaker 102.

Sequential Operation of Photographing Modes by Portable Telephone 600

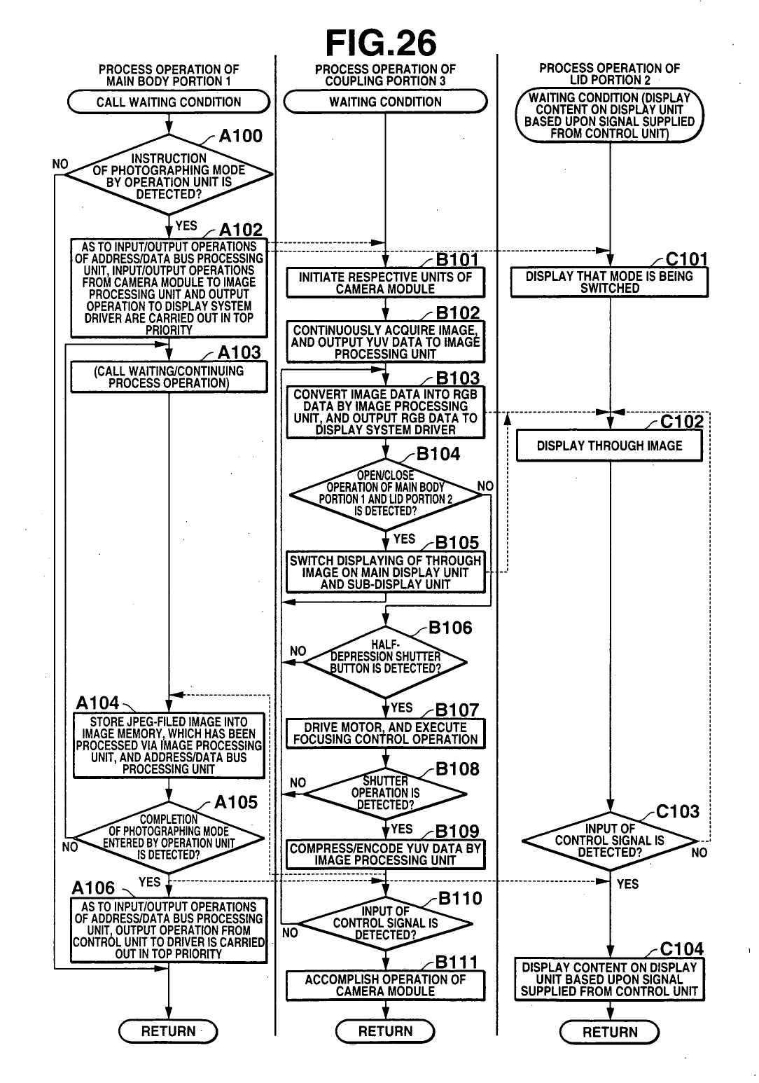

Referring now to a flow chart of FIG. 26, a description is made of a sequential operation of the portable telephone 600 according to this embodiment mode 5 after the operation mode thereof is advanced to a photographing mode until the photographing mode is accomplished.

In this flow chart, first of all, the control unit 122 detects a transfer instruction of a photographing mode instructed by a user, since the lens barrier open/close detecting unit 1360 detects that the lens barrier 34 is opened (step A1). When the control unit 122 does not detect the transfer instruction of the photographing mode (“NO” in step A1), the sequential operation is directly accomplished.

In the case that the control unit 122 detects the instruction for advancing the operation mode to the photographing mode (“YES” in step A1) in this step A1, the control unit 122 instructs the address/data bus processing unit 123 to input/output data in such a manner that data is inputted/outputted from the camera module 300 to the image processing unit 131 in a top priority, and also, data is outputted from the image processing unit 131 to the display system driver 128 in a top priority (step A2). Then, the control unit 122 sends an instruction to the camera control unit 133 so as to initiate the respective internal units of the camera module 300, so that the operation mode thereof is advanced to a photographing mode (step B1). Further, the control unit 122 instructs the display system driver 128 so as to display such an image that the operation mode is being switched to the photographing mode on the display screen of either the main display unit 21 or the sub-display unit 22 (step C1).

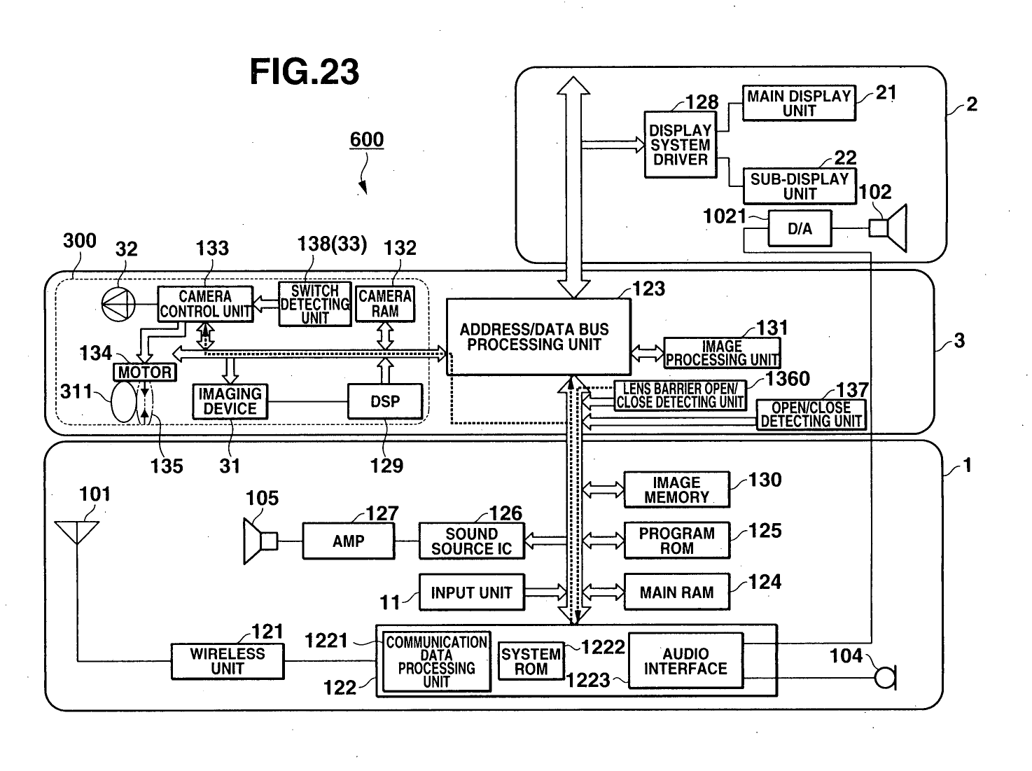

At this time, flows of the control signals produced in the above-described steps A1 and A2 are represented in FIG. 23.

FIG. 23 is a diagram for showing control signals by dot lines, which are produced until the lens barrier open/close detecting unit 1360 detects that the lens barrier 34 is opened, and an instruction is transmitted to the camera control unit 133 so as to initiate the camera module 300.

After the step B1, the camera control unit 133 outputs the image data (YUV signals) which has been photographed by the image capturing device 31 and then has been converted by the DSP 129 to the image processing unit 131 (step B2) The camera control unit 133 outputs image data whose image format has been converted into the display-purpose format such as RGB format by this image processing unit 131 to the display system driver 128 (step B3), and displays this RGB-formatted image on the main display unit 21 which is present on the side where this main display unit 21 is overlapped on the main body portion 1 in the case that the lens barrier 34 is under open status (refer to FIG. 17B and FIG. 18B). On the other hand, the camera control unit 133 displays this RGB-formatted image on the sub-display unit 22 which is present on the side where this sub-display unit 22 is not overlapped with the main body portion 1 in the case that the lens barrier 34 is under close status (refer to FIG. 17A and FIG. 18A) in a step C8.

In this connection, when the camera control unit 133 detects a transition from the open status to the close status, or another transition from the close status to the open status in response to a detection signal derived from the open/close detecting unit 137 (“YES” in step B4), the camera control unit 133 switches the display of the image to either the main display unit 21 or the sub-display unit 22 (step B5).

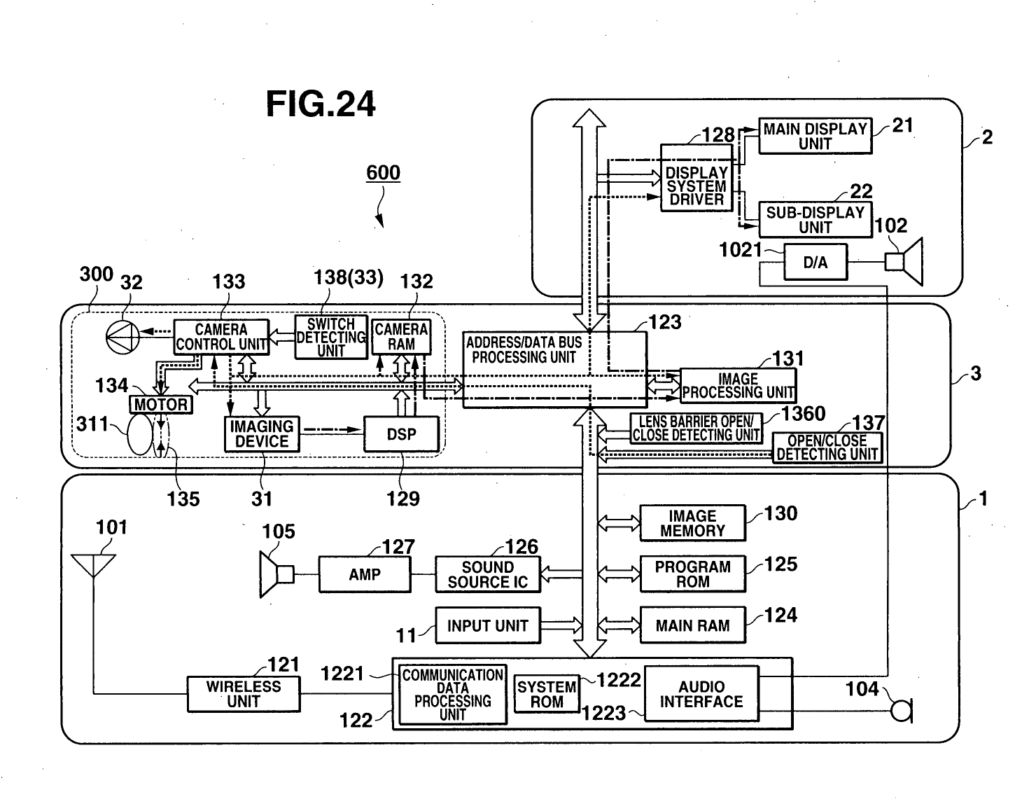

In this connection, FIG. 24 shows flows of the control signal and flows of the image signals in the above-explained steps B1 to B5, and step C2.

FIG. 24 is a diagram for representing both the control signals (indicated by dot lines) and the image signals (indicated by dot and dash lines), capable of realizing a view finder function in such a way that the respective units of the camera module 300 are initiated and controlled in response to the instructions of the camera control unit 133, so that the image photographed by the image capturing device 31 is displayed as the through image on the display screen.

As indicated in FIG. 24, the process operation for realizing the view finder function is carried out by such a manner that the camera control unit 133 controls the respective circuit units employed in the lid portion 2 and the coupling portion 3. During this process operation capable of realizing the view finder function, the control unit 122 is brought into a waiting condition for waiting a telephone call issued from the wireless unit 121, or brought into a communication condition (step A3), and the control operations by this control unit 122 can be concentrated to other processing operation such as the telephone call receiving process operation, or the data communication operation. As a result, the appliance of the portable telephone 600 can be effectively operated.

Next, when the display process operation of the through image is carried out in the steps B1 to B5 and the step C2, the camera control unit 133 detects the half-depression status of the shutter button 32 by the switch detecting unit 138 (“YES” in step B6), and then, drives the motor 134 so as to execute the focusing control operation (“YES” in step B7), and detects the actual depression status of the shutter button 32 (“YES” in step B8). The camera control unit 133 controls the image processing unit 131 to perform the converting process operation and the compressing/coding process operation as to the image data (YUV signals) photographed by the image capturing device 31 into the predetermined image format thereof (step B9), and then, transmits the processed image data to the control unit 122.

Then, the control unit 122 stores the image data transmitted from the image processing unit 131 into the image memory 130 (step A4), and is brought into a waiting condition in such a manner that the control unit 122 executes the process operations defined from the step A2 to the step A4 until a detection is made of closing of the lens barrier 34 (step A5).

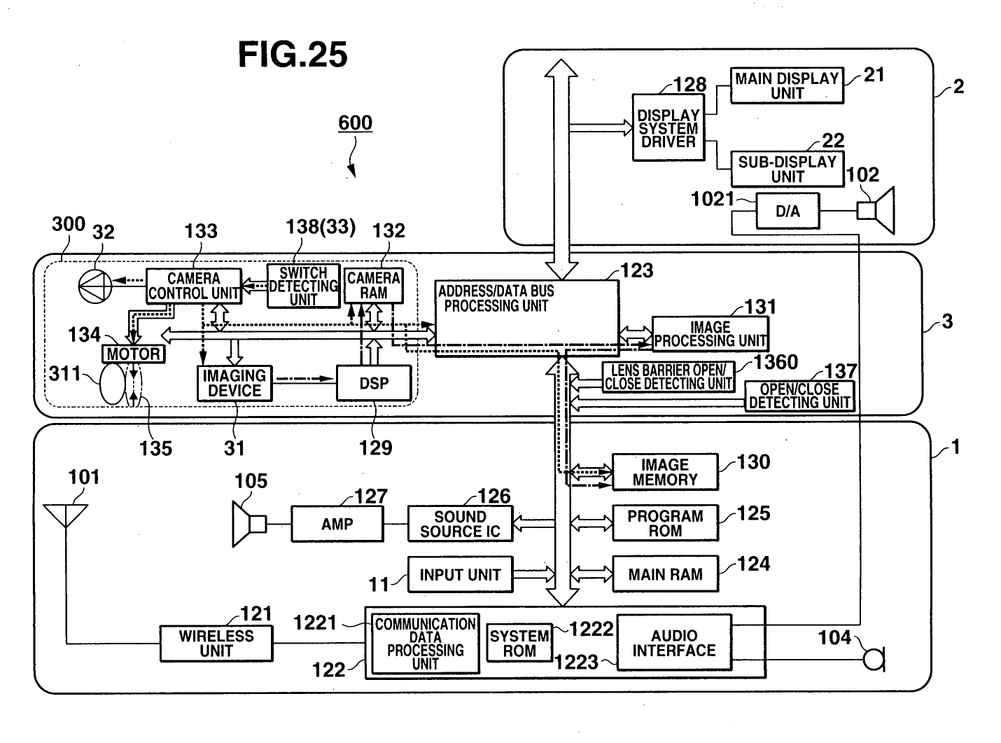

FIG. 25 shows flows of the control signals and flows of the image signals in the steps B6 to B9, and the step A4.

FIG. 25 is a diagram for showing operations of the portable telephone 600, in which an image which has been photographed by the image capturing device 31 in response to a depression of the shutter button 32 is converted by the image processing unit 131, and thereafter, the converted image is stored in the image memory 130. As a consequence, the control unit 122 may merely execute such a process operation that the control unit 122 stores the image data acquired by depressing the shutter button 32 while the user confirms the photographic object 34 by using the view finder function, so that the control operation of the control unit 122 can be concentrated to other processing operations such as the communication operation.

In a step A5, when the completion of the photographing mode by checking that the lens barrier 34 is closed is detected (“YES” in step A5), the control unit 122 outputs control signals as to the completion of the photographing mode to both the camera control unit 133 and the display system driver 128, and instructs the address/data bus processing unit 123 to input/output the data derived from the control unit 122 into/from the own address/data bus processing unit 123 in a top priority (step A6), and then, accomplishes the process operation.

Also, the camera control unit 133 detects the input of the control as to the photographing mode completion (“YES” in step B10), so that the camera control unit 133 accomplishes the operations of the respective units employed in the camera module 300 (step B11). When the display system driver 128 receives the control signal as to the photographing mode completion (“YES” in step C3), the display system driver 128 switches an image which is displayed on the display screen of either the main display unit 21 or the sub-display unit 22 to the signal inputted from the control unit 122 (step C4), and then, accomplishes the process operation.

As previously described, in the portable telephone 600 of this embodiment mode 5, the camera module 300 can be initiated by the lens barrier open/close detecting unit 1360 which detects the open/close statuses of the lens barrier 34, and the photographed images are displayed on both the planes of the lid portion 2. The image photographed by the camera unit 31 can be confirmed irrespective of either the folded condition or the opened condition.

Also, since the portable telephone 600 is arranged by that the control operation for the camera module 300 and the control operation for the wireless unit 121 are separately carried out, the control operations can be carried out in a smooth manner without giving the adverse influence.

Also, the portable telephone 600 is arranged by that the open/close detecting unit 137 detects the folded condition and the opened condition of the main body portion 1 and the lid portion 2 so as to switch the display screen of the photographed image with respect to the main display unit 21, or the sub-display unit 22. As a result, the displaying operation of the unnecessary display screen can be suppressed, so that while the power consumption can be suppressed, the photographed image can be displayed in a higher efficiency.

Also, since the portable telephone 600 is arranged by that both the camera module 300 and the camera control unit 133 are provided in the coupling portion 3 whereas both the wireless unit 121 and the control unit 122 are provided in the main body portion 1, the noise can be reduced which may give the adverse influences when the portable telephone 600 is operated in the camera mode and in the wireless communication mode.

Also, since the address/data bus processing unit 123 for controlling the data communication is provided between the camera module 300, the display system driver 128, and the main body portion 1, the image data is not entered into the main body portion 1, and also, the data bus provided on the side of the main body portion 1 is not occupied by the image data when the image photographed by the camera module 300 is displayed on either the main display unit 21 or the sub-display unit 22. As a result, the adverse influence given to the process operation by the wireless unit 121 employed in the main body portion 1 can be suppressed.

Furthermore, since the portable telephone 600 is arranged by that the communication operation of the image data from the camera module 300 to either the main display unit 21 or the sub-display unit 22 during the photographing operation is carried out in a top priority, as compared with the communication from the main body portion 1, the photographed image can be displayed in real time in the smooth manner.

In the above-described embodiment modes, the portable telephones have been described as the image capturing apparatus, but the present invention is not limited thereto. Alternatively, the image capturing apparatus of the present invention may be realized in the form of portable electronic appliances including PDAs (personal digital assistants) and other portable communication terminal appliances.

Also, the shapes of the coupling portions may be arbitrarily determined. Other concrete detailed constructions may be properly modified. For instance, alternatively, both a main body portion and a lid portion may be commonly coupled to a coupling portion by employing a hinge. Alternatively, a lens barrier may be constituted by a detachable type lens barrier, instead of the above-explained slide mechanism.

1. An image capturing apparatus comprising:
a main body portion;
a lid portion; and
a coupling portion which contains a first pivotable shaft coupled to said main body portion, a second pivotable shaft coupled to said lid portion, a lens in which a direction for intersecting both said first pivotable shaft and said second pivotable shaft respectively at a substantially right angle is set as an optical axis of said lens, and image capturing unit for imaging a photographic object entered thereinto via said lens.

2. An image capturing apparatus as claimed in claim 1 wherein:
said main body portion is comprised of operation unit;
said lid portion is comprised of first display unit; and
said image capturing apparatus is further comprised of:
capture control unit for controlling said image capturing unit based upon the operation by said operation unit; and
first display control unit for displaying an image acquired by said image capturing unit under control of said capture control unit on said first display unit.

3. An image capturing apparatus as claimed in claim 2 wherein:
said coupling portion owns a first mode and a second mode in accordance with a front/rear relationship between said first pivotable shaft and said second pivotable shaft, while in said first mode, said first display unit and said optical axis of the lens are faced along the same direction, whereas in said second mode, said first display unit and said optical axis of the lens are faced along opposite directions; and wherein:
said image capturing apparatus is further comprised of:
judging unit for judging as to whether an imaging operation is carried out in said first mode, or in said second mode; and in which:
said first display control unit changes a display direction in accordance with the mode judged by said judging unit.

4. An image capturing apparatus as claimed in claim 2, further comprising:
wireless communication unit for performing a wireless communication process operation with respect to an external unit;
second display control unit for displaying information related to said wireless communication process operation by said wireless communication unit on said first display unit; and
process control unit operated in such a manner that when an imaging operation is carried out by said image capturing unit under control of said image control unit, the display control operation by said first display control unit is carried out in a top priority, as compared with the display control operation by said second display control unit.

5. An image capturing apparatus as claimed in claim 4 wherein:
said main body portion is further comprised of voice input unit;
said lid portion is further comprised of voice output unit; and
said image capturing apparatus is further comprised of:
wireless communication control unit for controlling said wireless communication unit in such a manner that voice inputted by said voice input unit is transmitted in a wireless manner to the external unit, and voice received from the external unit in a wireless manner is outputted by said voice output unit.

6. An image capturing apparatus as claimed in claim 1 wherein:
said coupling portion is further comprised of:
drive unit for driving said lens.

7. An image capturing apparatus as claimed in claim 1 wherein:
any one of said main body portion and said lid portion is further comprised of:
a storage portion for storing thereinto said lens.

8. An image capturing apparatus as claimed in claim 1 wherein:
said coupling portion is further comprised of:
instruction unit for instructing the imaging operation by said image capturing unit.

9. An image capturing apparatus as claimed in claim 1, further comprising:
second display unit which is exposed under such a condition that said main body portion is overlapped with said lid portion; and
third display control unit for displaying the image acquired by said image capturing unit under control of said capture control unit on said second display unit under such a condition that said main body portion is overlapped with said lid portion.

10. An image capturing apparatus as claimed in claim 1 wherein:
said coupling portion is further comprised of:
a lens barrier; and
start instructing unit for instructing a commencement of a photographing mode under such a condition that said lens is exposed by moving said lens barrier.

11. A camera module build in a housing equipped with a first pivotable shaft and a second pivotable shaft, comprising:
a lens in which a direction for intersecting both said first pivotable shaft and said second pivotable shaft respectively at a substantially right angle is set as an optical axis of said lens;
image capturing unit for imaging a photographic object entered via said lens; and
drive unit for driving said lens.

12. A camera module as claimed in claim 11, further comprising:
first data transferring unit located adjacent to one shaft of said first pivotable shaft and said second pivotable shaft, for displaying/outputting an image acquired by said camera module;
second data transferring unit located adjacent to the other shaft of said first pivotable shaft and said second pivotable shaft, for storing/outputting the image acquired by said camera module; and
switch unit for outputting data inputted by said second data transferring unit via said first data transferring unit.
